(19) United States
(12) Patent Application Publication
(10) Pub. No.: US 2017/0371492 A1
(43) Pub. Date: Dec. 28, 2017

(54) SOFTWARE-DEFINED SENSING SYSTEM CAPABLE OF RESPONDING TO CPU COMMANDS

(71) Applicant: Rich IP Technology Inc., Taipei (TW)

(72) Inventors: Han-Chang CHEN, New Taipei City (TW); Chung-Lin CHIA, Taoyuan City (TW); Chih-Wen WU, Miaoli County (TW); Yen-Hung TU, Taipei (TW); Jen-Chieh CHANG, New Taipei City (TW)

(21) Appl. No.: 15/688,479

(22) Filed: Aug. 28, 2017

Related U.S. Application Data
(63) Continuation-in-part of application No. 14/875,161, filed on Oct. 5, 2015, now Pat. No. 9,778,784.
Application No. 14/875,161 is a continuation-in-part of application No. 13/803,524, filed on Mar. 14, 2013, now Pat. No. 9,176,613.

(51) Int. Cl. G06F 3/041; G06F 3/044; G06F 3/038; G06F 3/14; G06F 3/0488

(52) U.S. Cl. CPC G06F 3/0418; G06F 3/14; G06F 3/0488; G06F 3/038; G06F 3/0414; G06F 3/044

(57) ABSTRACT

A software-defined sensing system capable of responding to CPU commands, including: at least one input operation sensing module; at least one driving unit for driving the at least one input operation sensing module via at least one first interface; at least one control unit for receiving at least one sensors-configuration command via at least one second interface to control the at least one driving unit; at least one central processing unit, having at least one first function library to provide at least one sensors-configuration setting function for determining the sensors-configuration command; and at least one application program having at least one sensors-configuration function call instruction for generating the sensors-configuration command to provide at least one input sensing function.

### INCORPORATION BY REFERENCE

This is a continuation in part application to application Ser. No. 14/875,161 “TOUCH DISPLAY DRIVING CIRCUIT CAPABLE OF RESPONDING TO CPU COMMANDS” which was filed on Oct. 5, 2015, and which is incorporated herein by reference in its entirety.

### BACKGROUND OF THE INVENTION

### Field of the Invention

The present invention relates to a software-defined sensing system capable of responding to CPU commands.

### Description of the Related Art

Please refer to FIG. 1, which illustrates a block diagram of a prior art driving structure for a touch display. As illustrated in FIG. 1, a driving circuit 100, in which a micro processor or a micro controller is included, receives pixel data D_{IMG} from a CPU 110 via an image data interface 101, and generates a set of pixel driving signals S_{DISP} according to the pixel data D_{IMG} to drive a touch display module 120, and thereby display an image. Besides, the driving circuit 100 drives the touch display module 120 via a set of touch signals S_{TP} to derive touch data D_{TOUCH}, and transmits the touch data D_{TOUCH} to the CPU 110 via a touch data interface 102. In touch applications of simple functions or small sizes, the micro processor or micro controller in the driving circuit 100 of prior art needs not to be very powerful to handle a task involved in the touch applications. However, as the demands for touch function become complex, the micro processor or micro controller in the driving circuit 100 may no longer afford the loading of a complex task demand. One solution is to use a powerful micro processor or micro controller in the driving circuit 100. However, this will increase the cost of the driving circuit 100 and affect the competitiveness of a touch product resulted thereby.

To solve the foregoing problem, a novel software-defined architecture capable of responding to CPU commands is needed.

### SUMMARY OF THE INVENTION

One objective of the present invention is to disclose a driving circuit capable of configuring and executing a touch detection procedure according to a CPU's commands.

Another objective of the present invention is to disclose a driving circuit capable of receiving touch configuration data from a CPU, wherein the touch configuration data includes multiple control bits for determining a connection configuration of at least one multiplexer, and a weighting configuration of at least one touch point.

Another objective of the present invention is to disclose a driving circuit capable of receiving touch configuration data from a CPU, wherein the touch configuration data includes at least one control bit for enabling/disabling at least one touch point.

Another objective of the present invention is to disclose a driving circuit capable of receiving touch configuration data from a CPU, and using the touch configuration data to execute a resistor-capacitor delay compensation function.

Another objective of the present invention is to disclose a driving circuit capable of receiving touch configuration data from a CPU, and using the touch configuration data to execute a dynamic driving function.

Another objective of the present invention is to disclose a driving circuit capable of receiving touch configuration data from a CPU, and using the touch configuration data to execute an adaptive driving function. Another objective of the present invention is to disclose a driving circuit capable of receiving touch configuration data from a CPU, and using the touch configuration data to execute a multi-stage driving function.

Another objective of the present invention is to disclose a driving circuit capable of receiving touch configuration data from a CPU, and using the touch configuration data to execute a three-dimensional touch detection function.

Another objective of the present invention is to disclose a driving circuit capable of receiving touch configuration data from a CPU, and using the touch configuration data to execute a GUI (graphical user interface) touch detection function.

Another objective of the present invention is to disclose a driving circuit capable of configuring a touch resolution profile and a touch sensitivity profile according to a CPU's commands so as to facilitate detecting a pressure profile on a touch operation area and/or a change of the pressure profile over time.

Another objective of the present invention is to disclose a driving circuit capable of configuring a touch resolution profile and a touch sensitivity profile according to a CPU's commands so as to facilitate detecting a finger print of a user and/or characteristic data thereof.

Another objective of the present invention is to disclose a driving circuit capable of configuring a touch resolution profile and a touch sensitivity profile according to a CPU's commands so as to facilitate detecting a palm print of a user and/or characteristic data thereof.

Another objective of the present invention is to disclose a driving circuit capable of configuring a touch resolution profile and a touch sensitivity profile according to a CPU's commands so as to facilitate detecting an ear image of a user and/or characteristic data thereof.

Another objective of the present invention is to disclose a software-defined sensing system capable of responding to CPU commands, which can provide a first function library and/or a second function library for an application program to utilize to specify at least one input sensing interface via modularized instructions, and thereby meet the requirement of at least one input sensing mode.

Another objective of the present invention is to disclose a software-defined sensing system capable of responding to CPU commands, which can provide at least one sensing spec according to instructions of an application program so as to determine a sensing signal detection mode and a sensed data output format.

Another objective of the present invention is to disclose a software-defined sensing system capable of responding to CPU commands, which can provide at least one sensing function according to instructions of an application program, and the at least one sensing function can be a physical parameter sensing function, a chemical parameter sensing function, or a biological parameter sensing function.

Still another objective of the present invention is to disclose a software-defined sensing system capable of responding to CPU commands, which can be applied to an intelligent input device, an intelligent vehicle control device, or an intelligent IOT (internet of things) device.

To attain the foregoing objectives, a touch display driving circuit capable of responding to CPU commands is proposed, the touch display driving circuit including:

a first interface for receiving pixel data and touch configuration data from a CPU;

a second interface for coupling with a touch display module; and

a control unit, which drives the touch display module via the second interface to show an image according to the pixel data, and executes a touch detection procedure on the touch display module via the second interface, wherein the touch detection procedure is determined according to the touch configuration data.

In one embodiment, the touch display driving circuit capable of responding to CPU commands further includes a third interface for transmitting touch data to the CPU, wherein the touch data is derived by the control unit during an execution of the touch detection procedure.

In one embodiment, the control unit includes a timing control unit, a source driver unit, a gate driver unit, a touch driver unit, and a touch detection unit.

In one embodiment, the control unit further includes a memory unit for storing the touch data.

In one embodiment, the touch display driving circuit capable of responding to CPU commands is implemented by a single integrated circuit.

In one embodiment, the touch display driving circuit capable of responding to CPU commands is implemented by multiple integrated circuits.

In one embodiment, the touch display module has a flat panel display and a touch array.

In one embodiment, the flat panel display is one selected from a group consisting of a thin-film-transistor display, an organic-light-emitting-diode display, a nanometer-carbon-tube display, a super-twisted-nematic display, and a field-emission display.

In one embodiment, the touch array is one selected from a group consisting of a capacitive type touch array, a resistive type touch array, an optical type touch array, an acoustic type touch array, a pressure sensing type touch array, and a radar type touch array.

In one embodiment, the first interface transmits data in a serial manner or a parallel manner.

In one embodiment, the touch configuration data includes multiple control bits.

In one embodiment, the multiple control bits included in the touch configuration data are used to determine a connection configuration of at least one multiplexer, and a weighting configuration of at least one touch point.

In one embodiment, the multiple control bits included in the touch configuration data are further used to enable/disable at least one touch point.

In one embodiment, the control unit uses the touch configuration data to execute the touch detection procedure to provide a resistor-capacitor delay compensation function.

In one embodiment, the control unit uses the touch configuration data to execute the touch detection procedure to provide a dynamic driving function.

In one embodiment, the control unit uses the touch configuration data to execute the touch detection procedure to provide an adaptive driving function.

In one embodiment, the control unit uses the touch configuration data to execute the touch detection procedure to provide a multi-stage driving function.

In one embodiment, the control unit uses the touch configuration data to execute the touch detection procedure to provide a three-dimensional touch detection function.

In one embodiment, the control unit uses the touch configuration data to execute the touch detection procedure to provide a GUI (graphical user interface) touch detection function.

To attain the foregoing objectives, another touch display driving circuit capable of responding to CPU commands is proposed, the touch display driving circuit including:

a first interface for receiving touch configuration data from a CPU;

a second interface for coupling with a touch module; and

a control unit, which drives the touch module via the second interface to execute a touch detection procedure, wherein the touch detection procedure is determined according to the touch configuration data.

In one embodiment, the touch display driving circuit capable of responding to CPU commands further includes a third interface for transmitting touch data to the CPU, wherein the touch data is derived by the control unit during an execution of the touch detection procedure.

In one embodiment, the touch module has a touch array, which is one selected from a group consisting of a capacitive type touch array, a resistive type touch array, an optical type touch array, an acoustic type touch array, a pressure sensing type touch array, and a radar type touch array.

In one embodiment, the touch display driving circuit capable of responding to CPU commands is implemented by a single integrated circuit.

In one embodiment, the touch display driving circuit capable of responding to CPU commands is implemented by multiple integrated circuits.

In one embodiment, the first interface transmits data in a serial manner or a parallel manner.

In one embodiment, the touch configuration data includes multiple control bits.

In one embodiment, the multiple control bits included in the touch configuration data are used to determine a connection configuration of at least one multiplexer, and a weighting configuration of at least one touch point.

In one embodiment, the multiple control bits included in the touch configuration data are further used to enable/disable at least one touch point.

To attain the foregoing objectives, another touch display driving circuit capable of responding to CPU commands is proposed, including:

a first interface for receiving pixel data and touch configuration data from a CPU and outputting touch report data to the CPU, wherein the first interface transmits data in a serial manner or a parallel manner and the touch configuration data includes multiple control bits;

a second interface for coupling with a touch display module;

a control unit, which drives the touch display module via the second interface to show an image according to the pixel data, executes a touch detection procedure on the touch display module via the second interface to derive touch detected data, and processes the touch detected data to generate the touch report data, wherein the touch detection procedure is determined according to the touch configuration data, the multiple control bits included in the touch configuration data are used to determine a connection configuration of at least one multiplexer to set a touch resolution profile, and a weighting configuration of at least one touch point to set a touch sensitivity profile, and the touch report data include data selected from a group consisting of data representing a sensed pressure profile exerted on the touch display module, data representing a finger print of a user, data representing a palm print, data representing an ear image, data representing at least one touched location, characteristic data of a finger print, characteristic data of a palm print, and characteristic data of an ear image.

In one embodiment, the control unit includes a timing control unit, a source driver unit, a gate driver unit, a touch driver unit, a touch detection unit, and an information processing unit.

In one embodiment, the touch display module includes an in-cell touch display or an on-cell touch display or an out-cell touch display.

In one embodiment, the touch display module further includes a pressure sensor module.

In one embodiment, the touch display module further includes a finger print detection module.

In one embodiment, the touch display module further includes a pressure sensor module and a finger print detection module.

In one embodiment, the touch detected data are derived from a capacitive touch plane of the touch display module, the touch detected data being raw data or processed data of the raw data.

In one embodiment, the touch detected data include data derived from the pressure sensor module.

In one embodiment, the touch detected data include data derived from the finger print detection module. In one embodiment, the touch report data further include data representing a change of the sensed pressure profile over time or data representing a change of a sensed touched area over time.

In one embodiment, the touch report data further include data representing a joystick style operation on a touch operation area, and the data representing a joystick style operation are derived according to a change of the sensed pressure profile over time or a change of a sensed touched area over time.

To attain the foregoing objectives, another touch display driving circuit capable of responding to CPU commands is proposed, including:

a first interface for receiving touch configuration data from a CPU;

a second interface for coupling with a touch module, wherein the touch module comprises a touch array selected from a group consisting of a capacitive type touch array, a resistive type touch array, an optical type touch array, an acoustic type touch array, a pressure sensing type touch array, and a radar type touch array, the touch display driving circuit is implemented by a single integrated circuit or by multiple integrated circuits;

a control unit, which executes a touch detection procedure on the touch module via the second interface to derive touch detected data, and processes the touch detected data to generate the touch report data, wherein the touch detection procedure is determined according to the touch configuration data; the touch configuration data includes multiple control bits; and the multiple control bits included in the touch configuration data are used to determine a connection configuration of at least one multiplexer to set a touch resolution profile, and a weighting configuration of at least one touch point to set a touch sensitivity profile; and the touch report data include data selected from a group consisting of data representing a sensed pressure profile exerted on the touch display module, data representing a finger print of a user, data representing a palm print, data representing an ear image, data representing at least one touched location, characteristic data of a finger print, characteristic data of a palm print, and characteristic data of an ear image.

In one embodiment, the touch display driving circuit further includes a third interface for transmitting the touch report data to the CPU.

In one embodiment, the multiple control bits included in the touch configuration data are further used to enable/disable the at least one touch point.

To attain the foregoing objectives, still another touch display driving circuit capable of responding to CPU commands is proposed, including:

a first interface for receiving pixel data and touch configuration data from a CPU and outputting touch report data to the CPU, wherein the first interface transmits data in a serial manner or a parallel manner and the touch configuration data includes multiple control bits;

a second interface for coupling with a touch display module;

a control unit, which drives the touch display module via the second interface to show an image according to the pixel data, executes a touch detection procedure on the touch display module via the second interface to derive touch detected data, and processes the touch detected data to generate the touch report data, wherein the touch detection procedure is determined according to the touch configuration data, the multiple control bits included in the touch configuration data are used to determine a connection configuration of at least one multiplexer to set a touch resolution profile, and a weighting configuration of at least one touch point to set a touch sensitivity profile, and the CPU processes the touch report data to get data representing a sensed pressure profile exerted on the touch display module, or characteristic data of a finger print or a palm or an ear of a user, or data representing a change of the sensed pressure profile over time, or data representing a change of a sensed touched area over time.

To attain the foregoing objectives, a software-defined sensing system capable of responding to CPU commands is proposed to implement an intelligent device, the software-defined sensing system including:

at least one input operation sensing module, each having a sensing plane consisting of at least one sensing element, the at least one sensing element having at least one sensing function selected from a group consisting of force sensing function, thermal sensing function, photo sensing function, magnetic field sensing function, electrical field sensing function, acoustic wave sensing function, radiation sensing function, chemicals sensing function and biosensing function;

at least one driving unit, each being used for driving one of the at least one input operation sensing module via at least one first interface to execute a sensing procedure, and receiving a kind of sensed information via the at least one first interface;

at least one control unit, each being used for receiving a sensors-configuration command via at least one second interface to generate the sensing procedure;

at least one central processing unit, having at least one first function library, the at least one first function library containing at least one sensors-configuration setting function to determine the sensors-configuration command; and

at least one application program, stored in at least one memory and to be executed by the at least one central processing unit;

wherein, each of the at least one application program has at least one sensors-configuration function call instruction, and each of the at least one sensors-configuration function call instruction corresponds to one of the at least one sensors-configuration setting function so that when the at least one central processing unit executes the at least one application program, the sensors-configuration command is generated according to a called function of the at least one sensors-configuration setting function, and the sensing procedure is determined by the sensors-configuration command, and at least one input sensing function is thereby provided.

In one embodiment, each of the at least one control unit has a microprocessor, a memory and an operating timing control unit.

In one embodiment, each of the at least one driving unit has a multiplexing circuit, and a digital-to-analog conversion circuit and/or an analog-to-digital conversion circuit.

In one embodiment, each of the at least one driving unit and each of the at least one control unit are embodied in separated integrated circuits.

In one embodiment, each of the at least one driving unit is integrated with one of the at least one control unit in an integrated circuit.

In one embodiment, each of the at least one control unit is integrated with one of the at least one central processing unit in an integrated circuit.

In one embodiment, the at least one control unit has at least one second function library, each of the at least one second function library contains at least one sensors-configuration determining function for generating a sensors-configuration data according one of the at least one sensors-configuration command to control one of the at least one driving unit, and thereby determine the sensing procedure.

In one embodiment, the application program is supported by an OS (operating system) in the central processing unit, and the first function library and/or the second function library are/is used by the application program to generate the at least one input sensing function and/or at least one sensing spec according to instructions of the application program.

In one embodiment, the application program is supported by a first OS (operating system) in the central processing unit, and the control unit has a local application program supported by a second OS (operating system), the first function library is used by the application program to generate at least one first function of the at least one input sensing function and/or at least one first sensing spec, and the second function library is used by the local application program to generate at least one second function of the at least one input sensing function and/or at least one second sensing spec.

In one embodiment, the sensors-configuration command is selected from a group consisting of sensing device enable/disable configuration command, sensing function configuration command, and sensing spec setting command.

In one embodiment, the second interface is a wired transmission interface or a wireless transmission interface, and the central processing unit communicates with an external device in a wired transmission way or a wireless transmission way.

In one embodiment, the at least one control unit communicates with the at least one central processing unit in a one-to-one way or a one-to-many way or a many-to-one way.

In one embodiment, the input sensing function is selected from a group consisting of multi-points touch function, force sensing function, hover sensing function, 3D scan sensing function, 2D image sensing function, fingerprint sensing function, palm-print sensing function, and face characteristics sensing function.

In one embodiment, the sensing procedure includes determining a connecting status of the at least one sensing element of one of the at least one input operation sensing module.

In one embodiment, the sensing procedure includes determining a scan rule for the at least one sensing element of one of the at least one input operation sensing module.

In one embodiment, the sensing procedure includes determining a data format of sensed information from one of the at least one input operation sensing module.

In one embodiment, the input operation sensing module includes a sensor array selected from a group consisting of capacitive sensor array, force sensor array, photo sensor array, acoustic wave sensor array, and magnetic field sensor array.

In one embodiment, at least one of the at least one input operation sensing module is a touch display device, and an image display procedure and a touch sensing procedure of the touch display device act on at least one same electrode simultaneously or non-simultaneously, or act on different electrodes simultaneously or non-simultaneously.

In one embodiment, the sensing procedure includes a dynamic sensing mode for one of the at least one driving unit to determine an operating timing and/or at least one sensing area of the sensing plane for the touch sensing procedure.

In one embodiment, a touch display device is combined with a plurality of the input operation sensing modules to provide a hybrid input operation sensing function.

In one embodiment, the intelligent device is an intelligent input device.

In one embodiment, the intelligent device is an intelligent vehicle control device.

In one embodiment, the intelligent device is an intelligent IOT (internet of things) device.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a block diagram of a prior art driving architecture of a touch display.

FIG. 2 illustrates a block diagram of a system having a touch/display function, the system including a preferred embodiment of a driving circuit of the present invention.

FIG. 3 illustrates a block diagram of a preferred embodiment of a control unit of FIG. 2.

FIG. 4 is an illustrative example of how the control unit of FIG. 3 executes a touch detection procedure.

FIG. 5(a) illustrates an embodiment of the driving circuit of FIG. 2 implemented by a highly integrated circuit.

FIG. 5(b) illustrates an embodiment of the driving circuit of FIG. 2 implemented by a driving circuit and a controller.

FIG. 5(c) illustrates an embodiment of the driving circuit of FIG. 2 implemented by a pixel driver circuit, a pixel scan controller, and a touch scan driving control circuit.

FIG. 5(d) illustrates an embodiment of the driving circuit of FIG. 2 implemented by a pixel scan driving control circuit and a touch scan driving control circuit.

FIG. 6 illustrates a scenario where the control unit of FIG. 2 utilizes touch configuration data to configure a touch detection procedure to provide a resistor-capacitor delay compensation function.

FIG. 7 illustrates a scenario where the control unit of FIG. 2 utilizes touch configuration data to configure a touch detection procedure to provide a dynamic driving function.

FIG. 8 illustrates a scenario where the control unit of FIG. 2 utilizes touch configuration data to configure a touch detection procedure to provide an adaptive driving function.

FIG. 9 illustrates a scenario where the control unit of FIG. 2 utilizes touch configuration data to configure a touch detection procedure to provide a multi-stage driving function.

FIG. 10 illustrates a scenario where the control unit of FIG. 2 utilizes touch configuration data to configure a touch detection procedure to provide a three-dimensional touch detection function.

FIG. 11 illustrates a scenario where the control unit of FIG. 2 utilizes touch configuration data to configure a touch detection procedure to provide a graphical user interface touch detection function.

FIG. 12(a)-12(d) illustrates four scan control flowcharts with the control unit of FIG. 2 receiving pixel data and touch configuration data in a parallel way.

FIG. 13(a)-13(d) illustrates four scan control flowcharts with the control unit of FIG. 2 receiving pixel data and touch configuration data in a serial way.

FIG. 14(a)-14(e) illustrates various functions that can be offered by the configurable touch resolution profile and the configurable touch sensitivity profile of the present invention.

FIG. 15 illustrates a block diagram of a software-defined sensing system capable of responding to CPU commands according to an embodiment of the present invention.

FIG. 16a illustrates a scenario that a driving unit and a control unit of the FIG. 15 are embodied in separated integrated circuits.

FIG. 16b illustrates a scenario that a driving unit and a control unit of the FIG. 15 are integrated together in an integrated circuit.

FIG. 16c illustrates a scenario that a control unit and a central processing unit of the FIG. 15 are integrated together in an integrated circuit.

FIG. 17a illustrates a scenario that a control unit and a central processing unit of the FIG. 15 communicate with each other in a one-to-one way.

FIG. 17b illustrates a scenario that a control unit and a central processing unit of the FIG. 15 communicate with each other in a one-to-many way or a many-to-one way.

FIG. 18a and FIG. 18b illustrate timing diagrams of image display and touch sensing for two embodiments of a dynamic sensing mode provide by the software-defined sensing system of FIG. 15.

FIG. 19a-19h illustrate a plurality of function library options provided by a first function library and/or a second function library according to eight embodiments of the present invention.

FIG. 20 illustrates a block diagram of a software-defined sensing system capable of responding to CPU commands according to another embodiment of the present invention.

FIG. 21 illustrates a scenario that the software-defined sensing system capable of responding to CPU commands of the present invention is used to implement an intelligent input device.

FIG. 22 illustrates a scenario that the software-defined sensing system capable of responding to CPU commands of the present invention is used to implement an intelligent vehicle control device.

FIG. 23 illustrates a scenario that the software-defined sensing system capable of responding to CPU commands of the present invention is used to implement an intelligent IOT device.

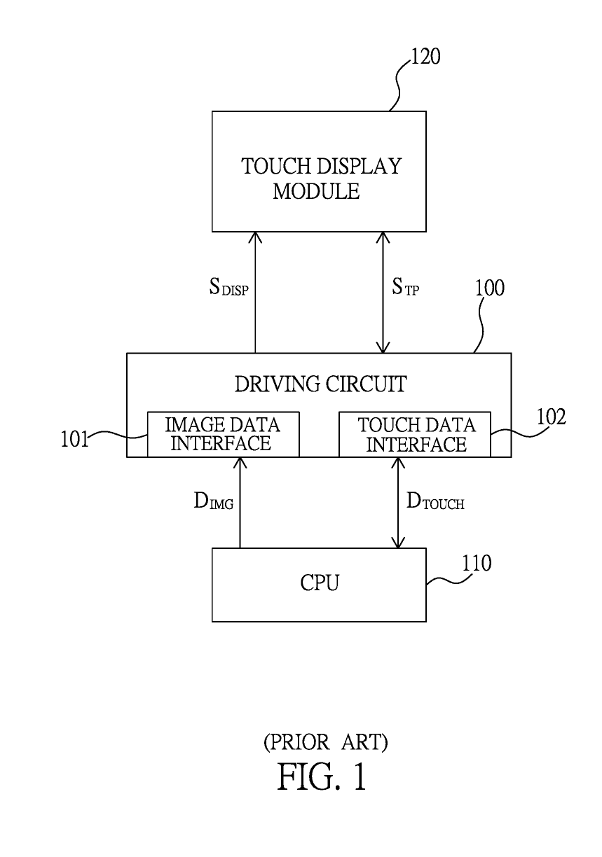

### DETAILED DESCRIPTION OF THE PREFERRED EMBODIMENTS

The present invention will be described in more detail hereinafter with reference to the accompanying drawings that show the preferred embodiments of the invention.

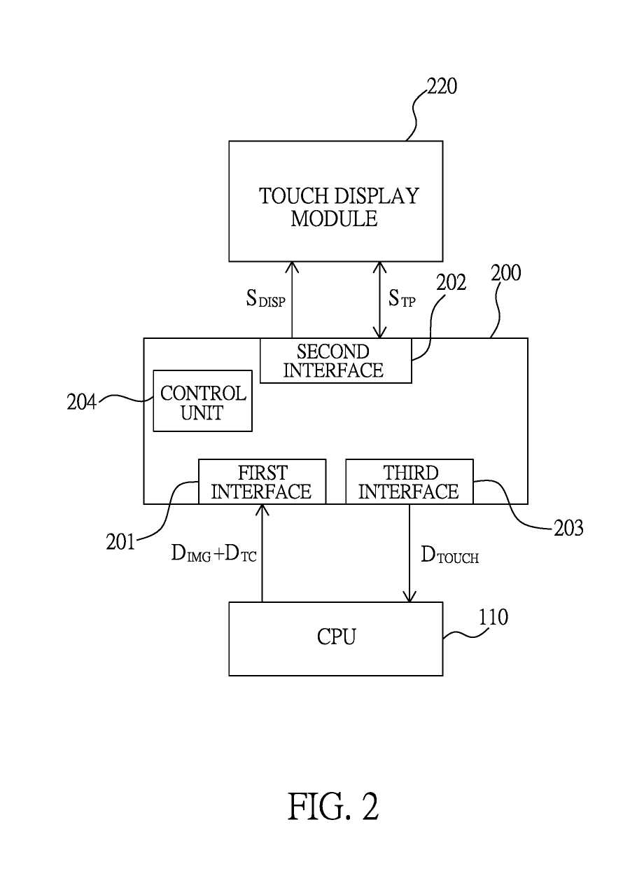

Please refer to FIG. 2, which illustrates a block diagram of a system having touch/display function, the system including a driving circuit according to a preferred embodiment of the present invention. As illustrated in FIG. 2, a driving circuit 200 is coupled with a CPU 210 and a touch display module 220 respectively, wherein the driving circuit 200 and the touch display module 220 form a touch display, and the CPU 210 can be located in a personal computer, a tablet computer, or any portable information processing device.

The driving circuit 200 has a first interface 201, a second interface 202, a third interface 203, and a control unit 204.

The first interface 201 is used to receive pixel data D_{IMG} and touch configuration data D_{TC} from the CPU 210, wherein the first interface 201 can transmit data in a serial manner or a parallel manner.

The second interface 202 is used to couple with the touch display module 220.

The third interface 203 is used to transmit touch data D_{TOUCH} to CPU 210, wherein the touch data D_{TOUCH} is derived by the control unit 204 during an execution of a touch detection procedure, and the third interface 203 can be an interface of I2C (inter integrated circuit), SPI (serial peripheral interface), 3W (3-wire), USB (universal serial bus), TTL (transistor-transistor logic), or LVDS (low voltage differential signal).

The control unit 204 uses the second interface 202 to drive the touch display module 220 to show an image according to the pixel data D_{IMG}, and executes the touch detection procedure on the touch display module 220 via the second interface 202, wherein, the touch detection procedure is determined according to the touch configuration data D_{TC}.

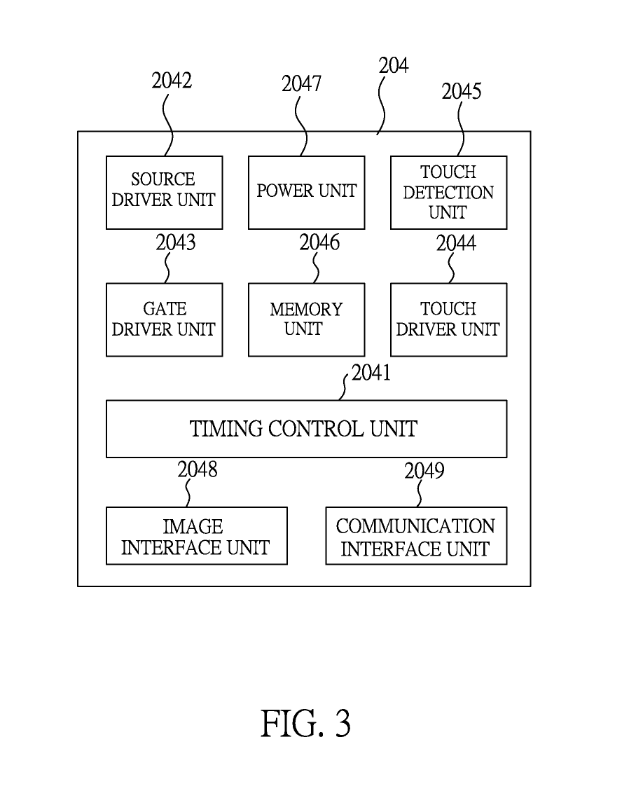

FIG. 3 illustrates a block diagram of a preferred embodiment of the control unit 204. As illustrated in FIG. 3, the control unit 204 has a timing control unit 2041, a source driver unit 2042, a gate driver unit 2043, a touch driver unit 2044, a touch detection unit 2045, a memory unit 2046, a power unit 2047, an image interface unit 2048, and a communication interface unit 2049.

The timing control unit 2041 is used to control an operation timing of the source driver unit 2042, the gate driver unit 2043, the touch driver unit 2044, and the touch detection unit 2045 according to the touch configuration data D_{TC}, so as to execute an image display procedure and/or the touch detection procedure.

The memory unit 2046 is used to store the touch data D_{TOUCH}.

The power unit 2047 can provide driving voltages for the source driver unit 2042 and the touch driver unit 2044.

The image interface unit 2048 is used to couple with the first interface 201 to receive the pixel data D_{IMG} and the touch configuration data D_{TC} from the CPU 210, and couple with the third interface 203 to transmit the touch data D_{TOUCH} to the CPU 210. The touch data D_{TOUCH} can include touch coordinates, a touch image, and vector information derived from multiple frames of the touch images, wherein the vector information can be used to predict a next touch location.

The communication interface 2049 is used to control data transmission of the first interface 201 and data transmission of the third interface 203.

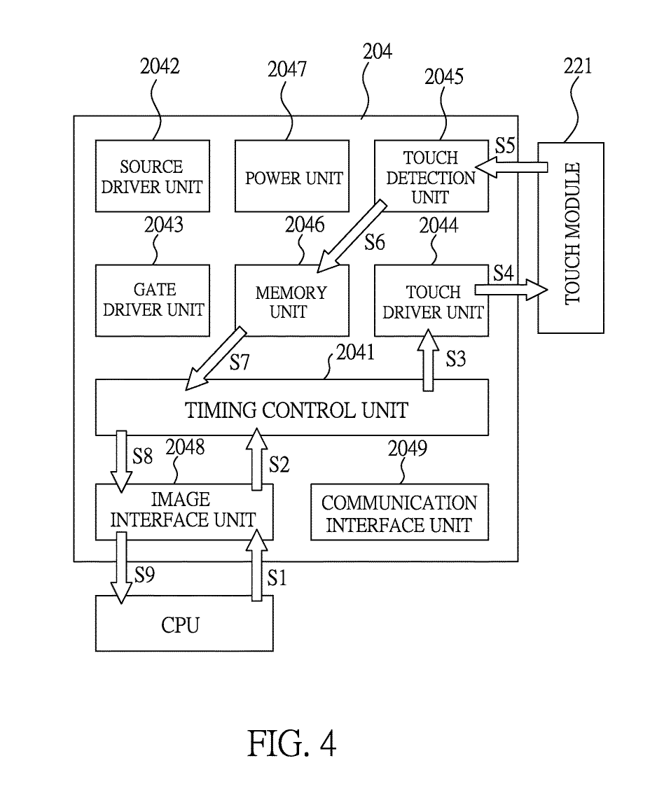

Please refer to FIG. 4, which is an illustrative example of how the control unit 204 of FIG. 3 executes the touch detection procedure. As illustrated in FIG. 4, in the first step, the CPU 210 transmits the touch configuration data D_{TC} to the image interface unit 2048. In the second step, the image interface unit 2048 transmits the touch configuration data D_{TC} to the timing control unit 2041. In the third step, the timing control unit 2041 makes the touch driver unit 2044 operate in a touch driving mode according to the touch configuration data D_{TC}, which includes multiple control bits for determining a connection configuration of at least one multiplexer and a weighting configuration of at least one touch point, and enabling/disabling the at least one touch point. In the fourth step, the touch driver unit 2044 drives a touch module 221 of the touch display module 220, wherein the touch module 221 has a touch array, which is one selected from a group consisting of a capacitive type touch array, a resistive type touch array, an optical type touch array, an acoustic type touch array, a pressure sensing type touch array, and a radar type touch array. In the fifth step, the touch module 221 transmits touch sensing signals to the touch detection unit 2045. In the sixth step, the touch detection unit 2045 transmits touch data, which is derived from the touch sensing signals, to the memory unit 2046. In the seventh step, the timing control unit 2041 reads the touch data from the memory unit 2046. In the eighth step, the timing control unit 2041 transmits the touch data to the image interface unit 2048. In the ninth step, the image interface unit 2048 transmits the touch data to the CPU 210.

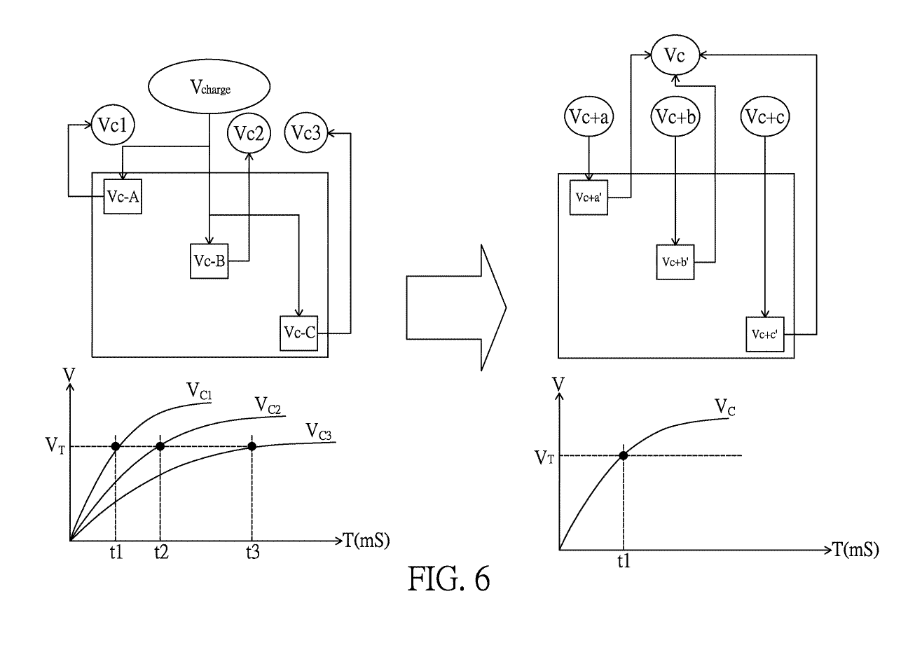

In one embodiment, the touch configuration data D_{TC} has 8 control bits D₀-D₇, wherein, D₀ is used to enable/disable at least one touch point; D₁-D₂ are used to control a connection configuration of at least one multiplexer—the connection configuration of the at least one multiplexer can combine multiple touch points into an effective touch point—to determine at least one touch detection area; D₃-D₄ are used to control a weighting configuration of at least one touch point to provide a touch discrimination effect, wherein the weighting configuration can alter a signal gain and/or a threshold voltage of the touch detection unit 2045 to generate the touch discrimination effect, and thereby meet a touch request of an application program executed by the CPU 210; and D₅-D₇ are used to control a charging voltage for at least one touch point. FIG. 6-11 illustrates multiple functions generated by taking advantage of the touch configuration data D_{TC}.

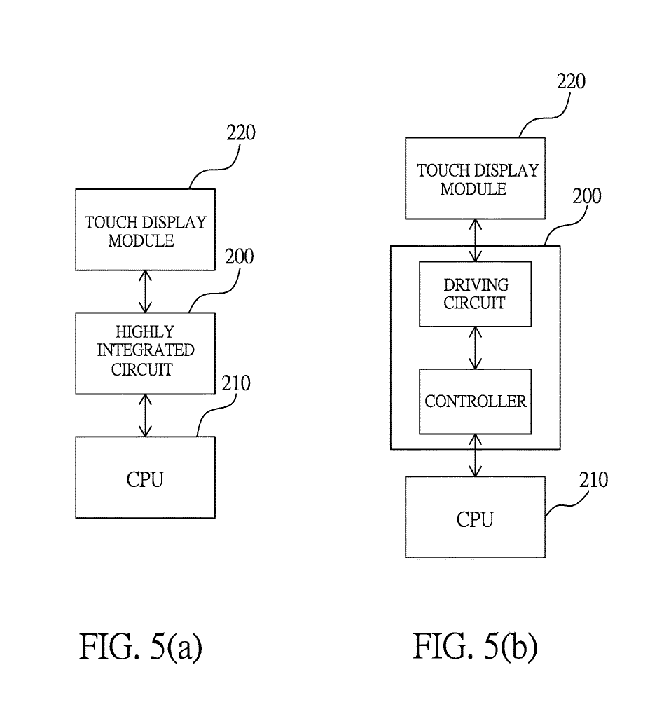

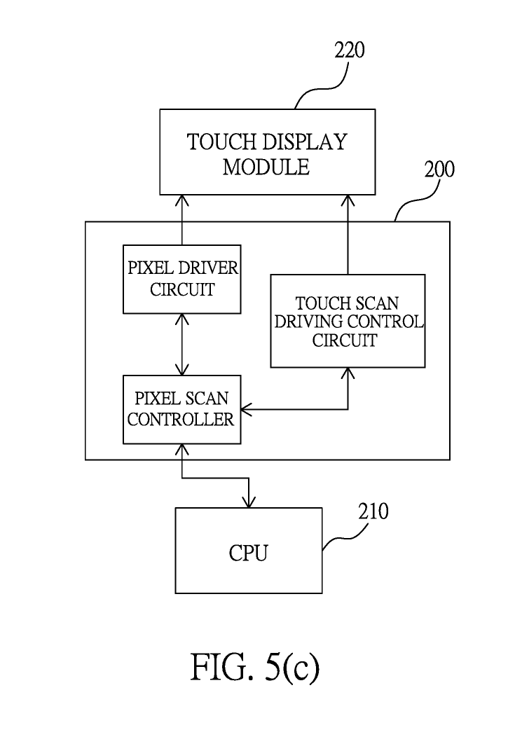

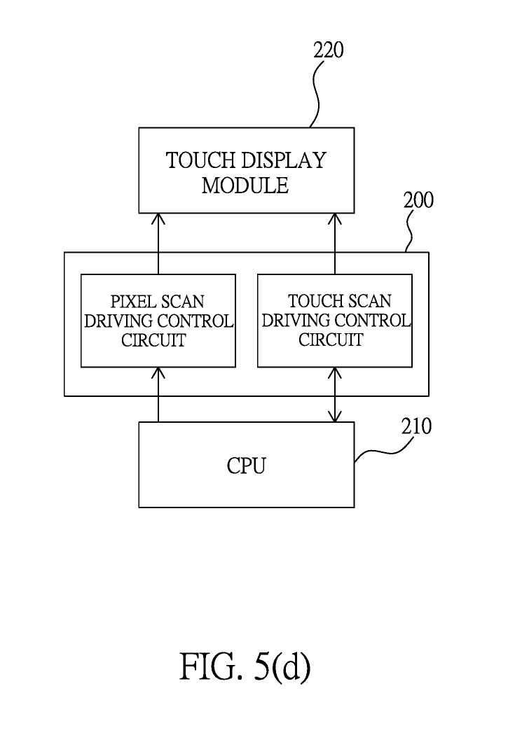

The driving circuit 200 can be implemented by a single integrated circuit or multiple integrated circuits. Please refer to FIG. 5(a)-5(d), wherein FIG. 5(a) illustrates an embodiment of the driving circuit 200 implemented by a highly integrated circuit; FIG. 5(b) illustrates an embodiment of the driving circuit 200 implemented by a driving circuit and a controller; FIG. 5(c) illustrates an embodiment of the driving circuit 200 implemented by a pixel driver circuit, a pixel scan controller, and a touch scan driving control circuit; and FIG. 5(d) illustrates an embodiment of the driving circuit 200 implemented by a pixel scan driving control circuit and a touch scan driving control circuit.

Besides, the touch display module 220 has a flat panel display, which is one selected from a group consisting of a thin-film-transistor display, an organic-light-emitting-diode display, a nanometer-carbon-tube display, a super-twisted-nematic display, and a field-emission display.

Thanks to the foregoing arrangement, the present invention can provide multiple functions. Please refer to FIG. 6, which illustrates a scenario where the control unit 204 utilizes the touch configuration data D_{TC} to configure the touch detection procedure to provide a resistor-capacitor delay compensation function. As illustrated in FIG. 6, if points A, B, C in a touch array are charged with a same voltage V_{charge}, three responding voltages V_{C1}, V_{C2}, V_{C3} will reach a threshold voltage V_{T} at different time points t1, t2, and t3. However, by utilizing the touch configuration data D_{TC}, the present invention can use three different voltages V_{c+a}, V_{c+b}, V_{c+c} to charge points A, B, C respectively, so that the three responding voltages reach the threshold voltage V_{T} at a same time point. By this arrangement, the resistor-capacitor delay compensation function is provided by the touch detection procedure of the present invention.

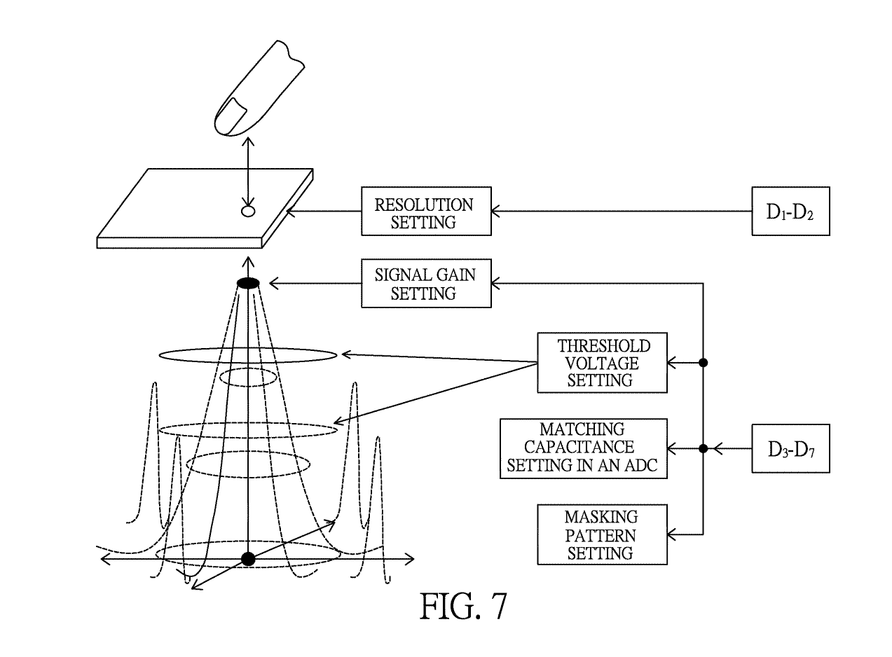

Please refer to FIG. 7, which illustrates a scenario where the control unit 204 utilizes the touch configuration data D_{TC} to configure the touch detection procedure to provide a dynamic driving function. As illustrated in FIG. 7, D₁-D₂ are used to set a resolution of a touch array, and D₃-D₇ are used to set a signal gain, a threshold voltage, a matching capacitance in an ADC (analog to digital conversion) circuit, and a masking pattern. By this arrangement, the dynamic driving function is provided by the touch detection procedure of the present invention.

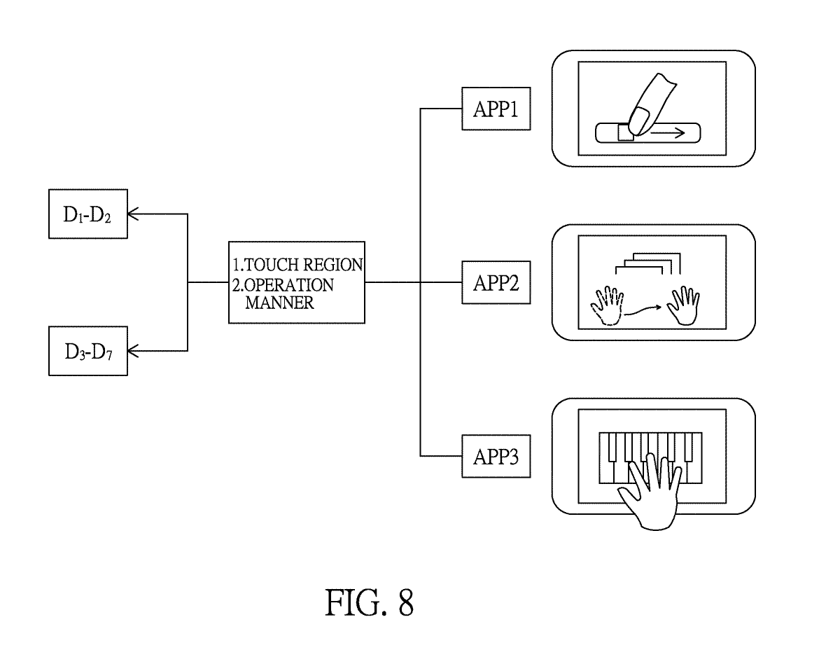

Please refer to FIG. 8, which illustrates a scenario where the control unit 204 utilizes the touch configuration data D_{TC} to configure the touch detection procedure to provide an adaptive driving function. As illustrated in FIG. 8, D₁-D₂ and D₃-D₇ are generated according to a touch region (by a finger or a palm) and an operation manner (dragging or pressing) demanded by an application program (APP1, APP2, or APP3), to configure the touch detection procedure to provide the adaptive driving function.

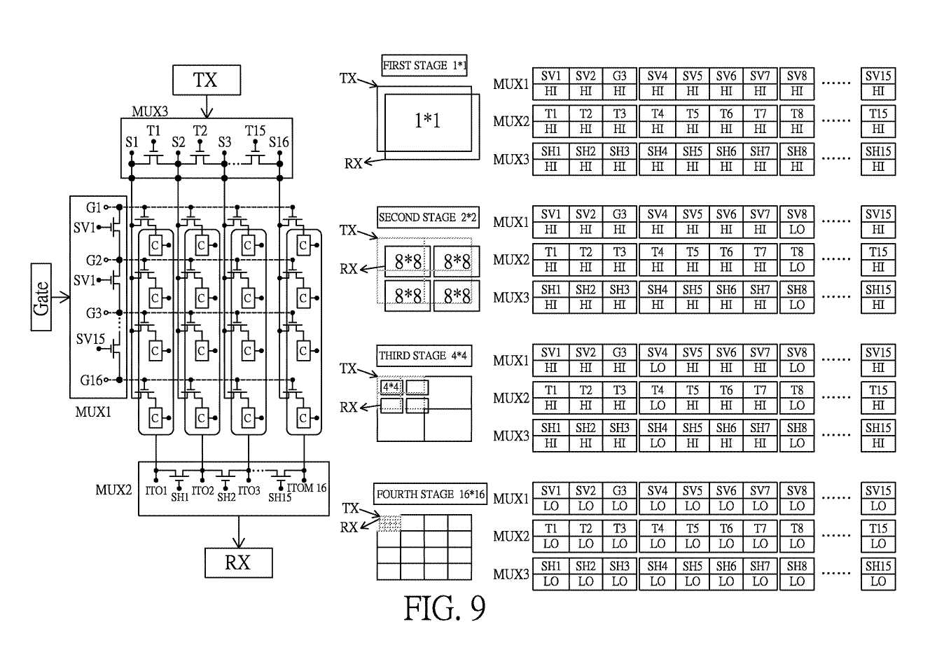

Please refer to FIG. 9, which illustrates a scenario where the control unit 204 utilizes the touch configuration data D_{TC} to configure the touch detection procedure to provide a multi-stage driving function. As illustrated in FIG. 9, by using the touch configuration data D_{TC} to control multiplexers MUX1-MUX3, a touch array is configured to have a resolution of 1*1 at first stage, a resolution of 2*2 at second stage, a resolution of 4*4 at third stage, and a resolution of 16*16 at fourth stage. By this arrangement, the multi-stage driving function is provided by the touch detection procedure of the present invention.

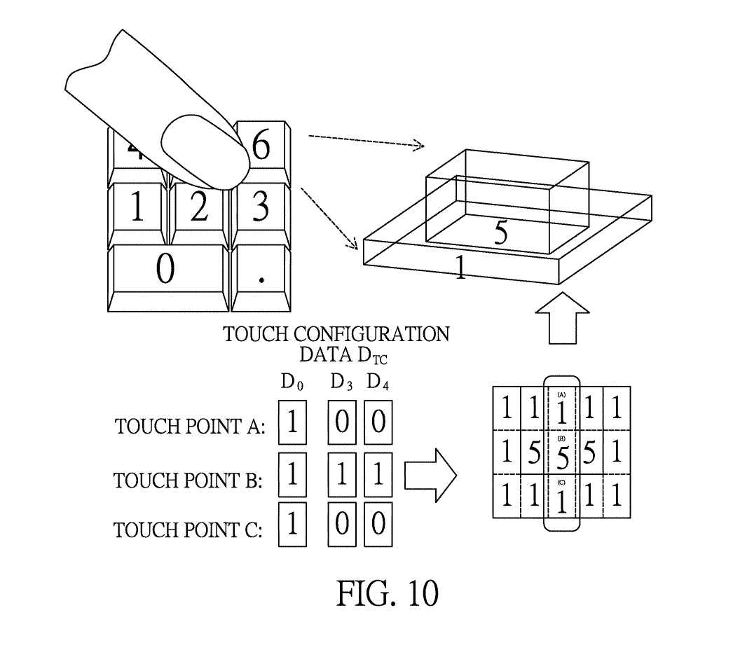

Please refer to FIG. 10, which illustrates a scenario where the control unit 204 utilizes the touch configuration data D_{TC} to configure the touch detection procedure to provide a three-dimensional touch detection function. As illustrated in FIG. 10, D₀ is used to enable/disable touch points (A, B, C for example) of a 3D GUI button; D₃-D₄ are used to determine corresponding weighting values of the touch points (A, B, C for example) of the 3D GUI button. By this arrangement, the three-dimensional touch detection function is provided by the touch detection procedure of the present invention.

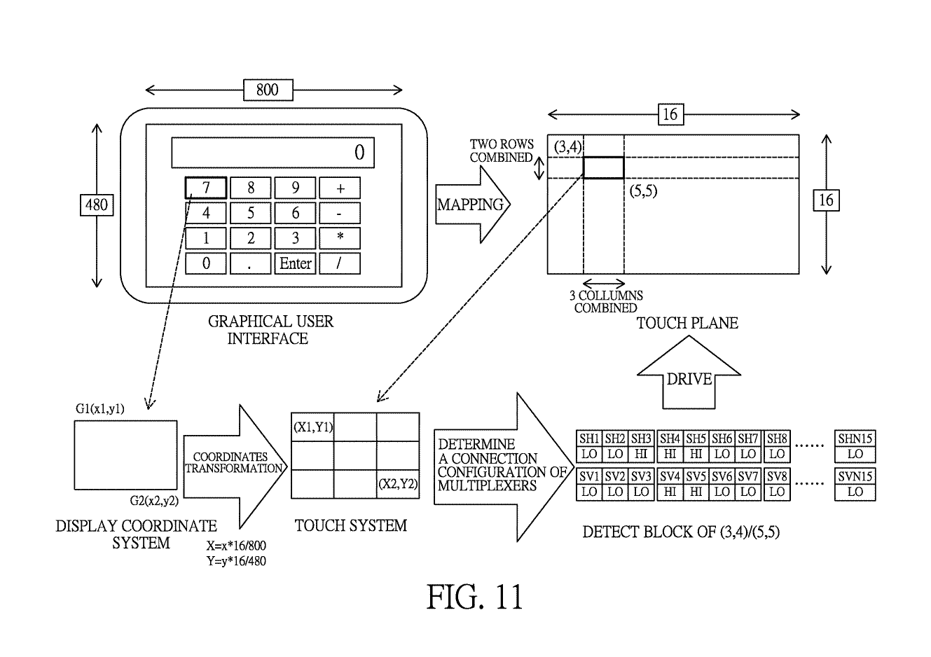

Please refer to FIG. 11, which illustrates a scenario where the control unit 204 utilizes the touch configuration data D_{TC} to configure the touch detection procedure to provide a graphical user interface touch detection function. As illustrated in FIG. 11, a graphical user interface of a resolution of 800*480 is mapped to a touch plane of 16*16. Each button of the graphical user interface has a corresponding area in the touch plane. Take button 7 for example: to detect a touch on the button 7, the touch configuration data D_{TC} can be used to determine a connection configuration of a multiplexer to scan a corresponding area in the touch plane of the button 7. By this arrangement, the graphical user interface touch detection function is provided by the touch detection procedure of the present invention.

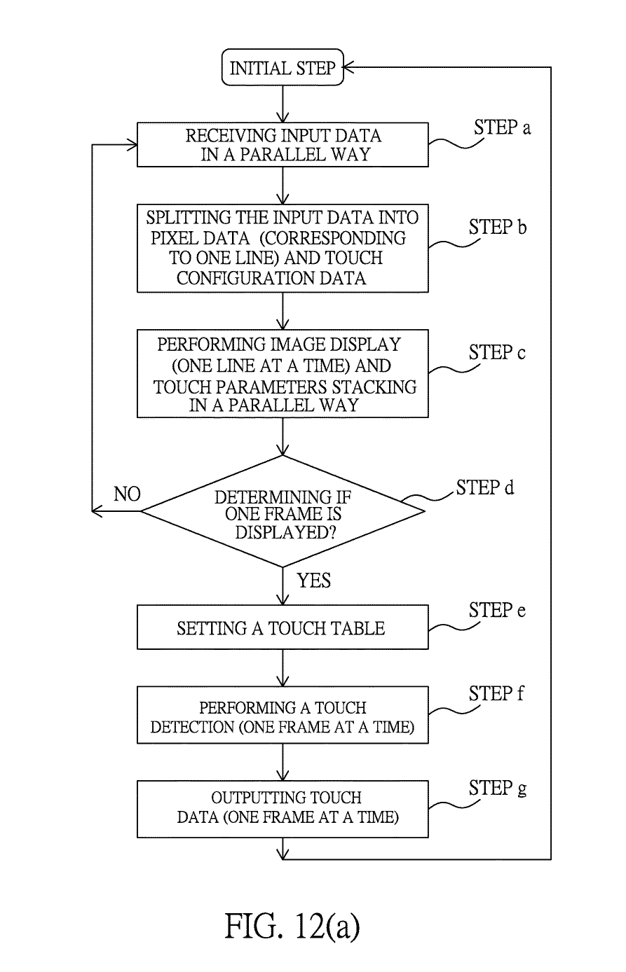

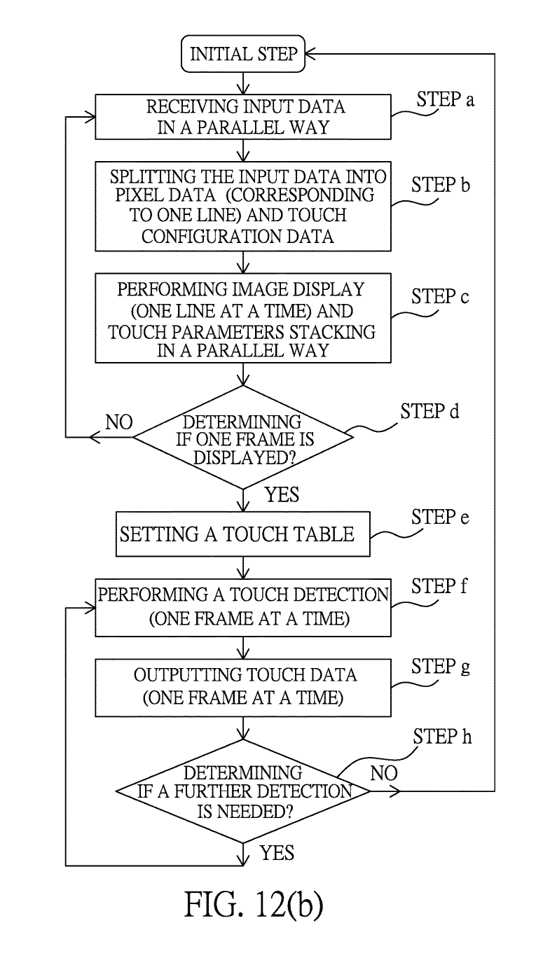

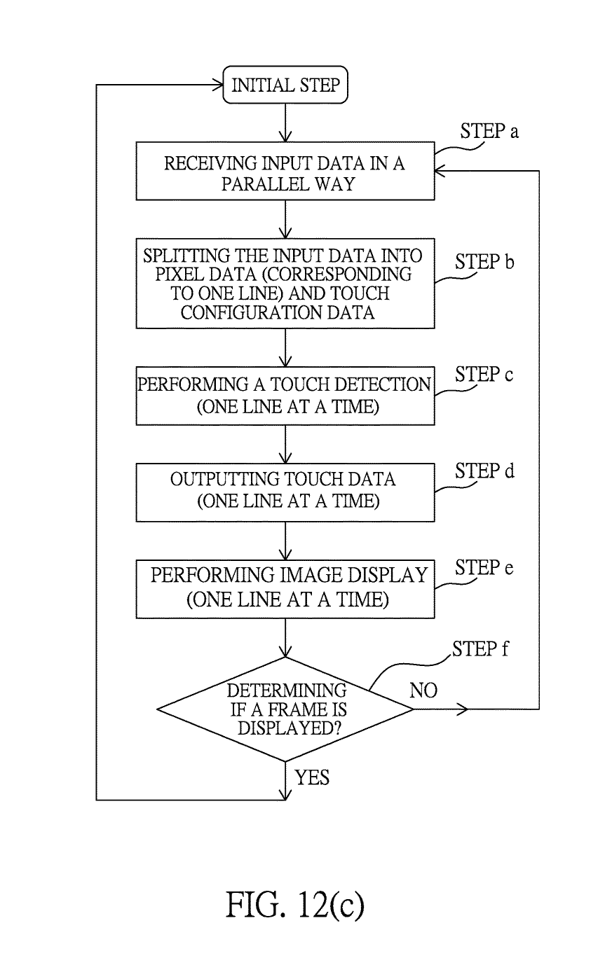

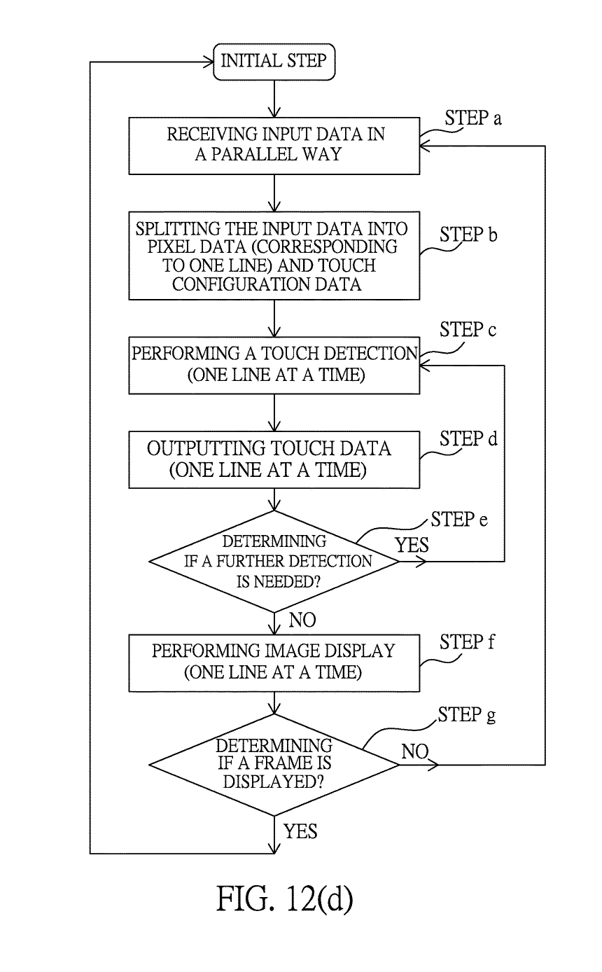

FIG. 12(a)-12(d) illustrates four scan control flowcharts with the control unit 204 receiving the pixel data D_{IMG} and the touch configuration data D_{TC} in a parallel way.

FIG. 12(a) illustrates a scan control flowchart, including: receiving input data in a parallel way (step a); splitting the input data into pixel data (corresponding to one line) and touch configuration data (step b); performing image display (one line at a time) and touch parameters stacking in a parallel way (step c); determining if one frame is displayed? If yes, then go to step e; if no, go to step a (step d); setting a touch table (step e); performing a touch detection (one frame at a time) (step f); and outputting touch data (one frame at a time) (step g).

FIG. 12(b) illustrates another scan control flowchart, including: receiving input data in a parallel way (step a); splitting the input data into pixel data (corresponding to one line) and touch configuration data (step b); performing image display (one line at a time) and touch parameters stacking in a parallel way (step c); determining if one frame is displayed? If yes, then go to step e; if no, go to step a (step d); setting a touch table (step e);

performing a touch detection (one frame at a time) (step f); outputting touch data (one frame at a time) (step g); and determining if a further detection is needed? If yes, then go to step f; if no, go back to an initial step of this flowchart (step h).

FIG. 12(c) illustrates another scan control flowchart, including: receiving input data in a parallel way (step a); splitting the input data into pixel data (corresponding to one line) and touch configuration data (step b); performing a touch detection (one line at a time) (step c); outputting touch data (one line at a time) (step d); performing image display (one line at a time) (step e); and determining if a frame is displayed? If yes, then go back to an initial step of this flowchart; if no, go to step a (step f).

FIG. 12(d) illustrates another scan control flowchart, including: receiving input data in a parallel way (step a); splitting the input data into pixel data (corresponding to one line) and touch configuration data (step b); performing a touch detection (one line at a time) (step c); outputting touch data (one line at a time) (step d); determining if a further detection is needed? If yes, then go to step c; if no, go to step f (step e); performing image display (one line at a time) (step f); and determining if a frame is displayed? If yes, then go back to an initial step of this flowchart; if no, go to step a (step g).

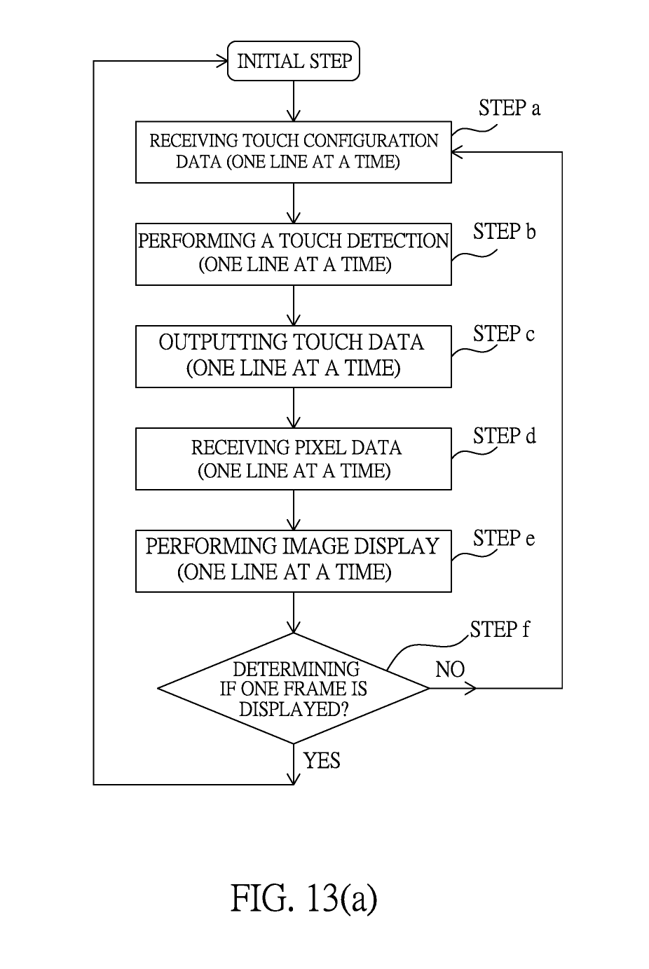

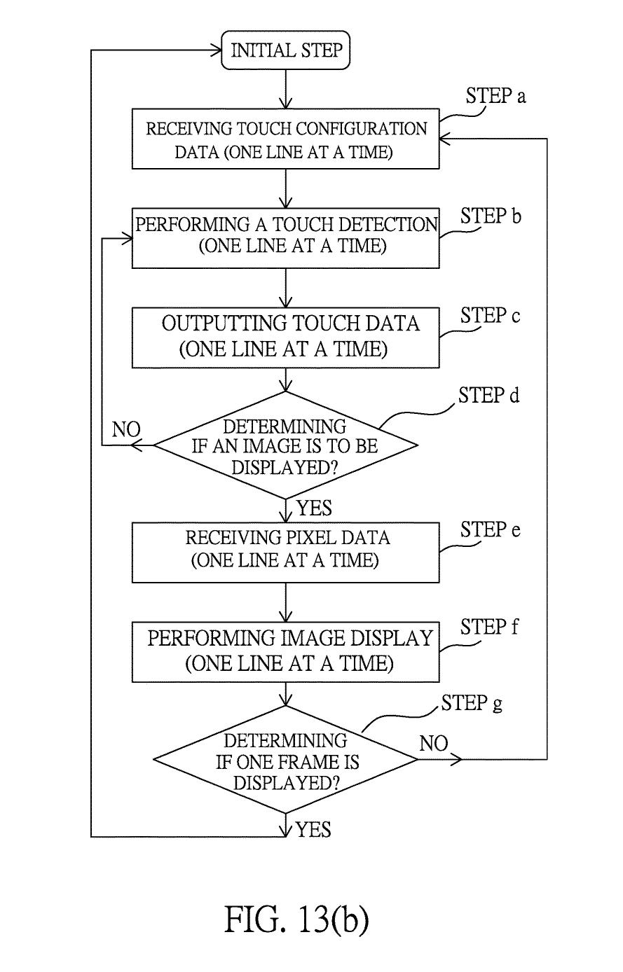

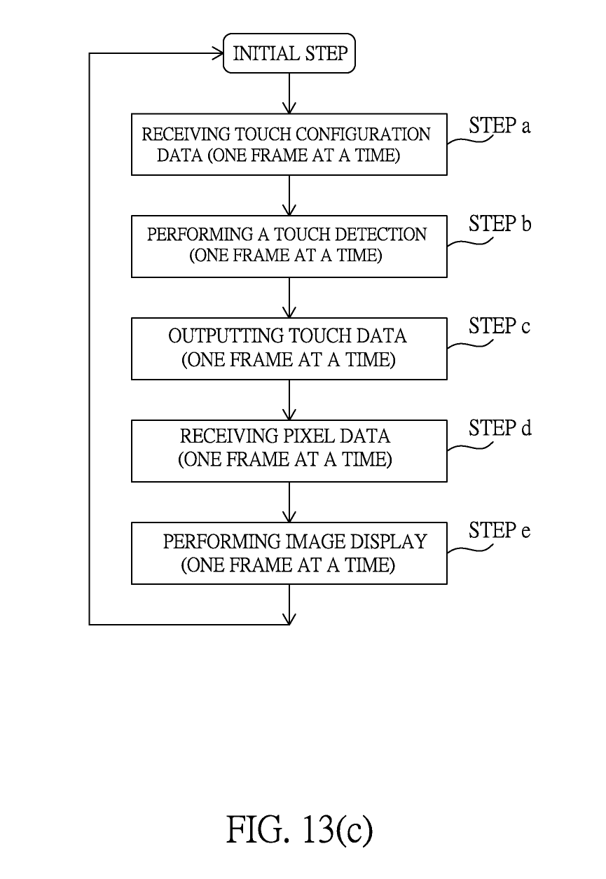

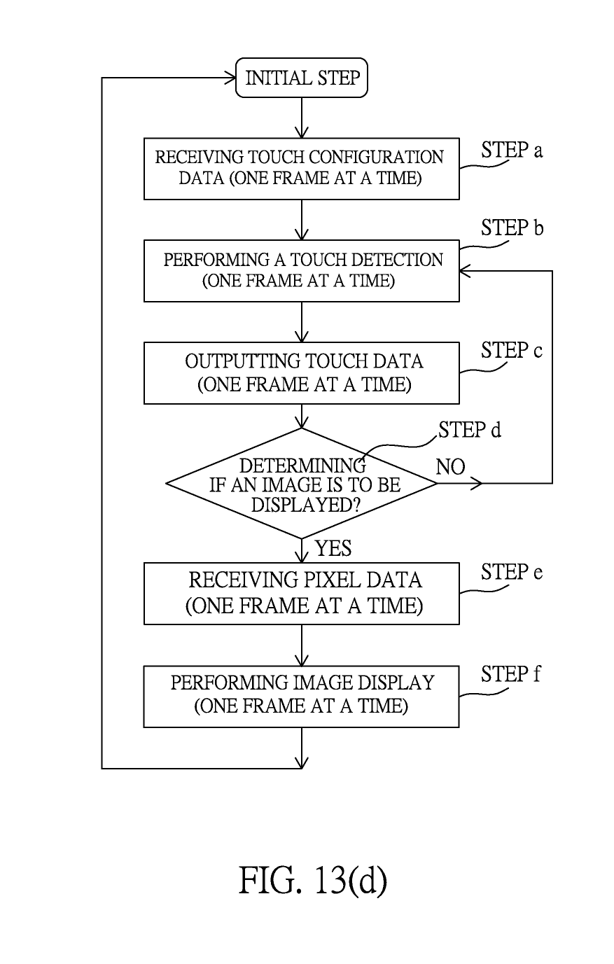

FIG. 13(a)-13(d) illustrates four scan control flowcharts with the control unit 204 receiving the pixel data D_{IMG} and the touch configuration data D_{TC} in a serial way.

FIG. 13(a) illustrates a scan control flowchart, including: receiving touch configuration data (one line at a time) (step a); performing a touch detection (one line at a time) (step b); outputting touch data (one line at a time) (step c); receiving pixel data (one line at a time) (step d); performing image display (one line at a time) (step e); and determining if one frame is displayed? If yes, then go to an initial step of this flowchart; if no, go to step a (step f).

FIG. 13(b) illustrates another scan control flowchart, including: receiving touch configuration data (one line at a time) (step a); performing a touch detection (one line at a time) (step b); outputting touch data (one line at a time) (step c); determining if an image is to be displayed? If yes, then go to step e; if no, go to step b (step d); receiving pixel data (one line at a time) (step e); performing image display (one line at a time) (step f); and determining if one frame is displayed? If yes, then go to an initial step of this flowchart; if no, go to step a (step g).

FIG. 13(c) illustrates another scan control flowchart, including: receiving touch configuration data (one frame at a time) (step a); performing a touch detection (one frame at a time) (step b); outputting touch data (one frame at a time) (step c); receiving pixel data (one frame at a time) (step d); and performing image display (one frame at a time) (step e).

FIG. 13(d) illustrates another scan control flowchart, including: receiving touch configuration data (one frame at a time) (step a); performing a touch detection (one frame at a time) (step b); outputting touch data (one frame at a time) (step c); determining if an image is to be displayed? If yes, then go to step e; if no, go to step b (step d); receiving pixel data (one frame at a time) (step e); and performing image display (one frame at a time) (step f).

In addition to driving a touch display module, the driving circuit of the present invention can also be used to drive a touch module. For example, the touch display driving circuit capable of responding to CPU commands of the present invention can include:

a first interface for receiving touch configuration data from a CPU;

a second interface for coupling with a touch module; and

a control unit, which drives the touch module via the second interface to execute a touch detection procedure, wherein the touch detection procedure is determined according to the touch configuration data; and the touch module has a touch array, which is one selected from a group consisting of a capacitive type touch array, a resistive type touch array, an optical type touch array, an acoustic type touch array, a pressure sensing type touch array, and a radar type touch array.

Besides, the touch display driving circuit capable of responding to CPU commands can be implemented by a single integrated circuit or multiple integrated circuits.

The first interface can be used to transmit data in a serial manner or a parallel manner.

The touch configuration data includes multiple control bits.

The multiple control bits can be used to determine a connection configuration of at least one multiplexer, and a weighting configuration of at least one touch point.

The multiple control bits can be further used to enable/disable at least one touch point.

Following the architecture and principle disclosed above, the present invention can be used to implement many touch functions like pressure sensing, finger print verification, palm print verification, ear image verification, or 3 dimensional touch sensing. One embodiment is as follows: a touch display driving circuit capable of responding to CPU commands, including:

a first interface for receiving pixel data and touch configuration data from a CPU and outputting touch report data to the CPU, wherein the first interface transmits data in a serial manner or a parallel manner and the touch configuration data includes multiple control bits;

a second interface for coupling with a touch display module;

a control unit, which drives the touch display module via the second interface to show an image according to the pixel data, executes a touch detection procedure on the touch display module via the second interface to derive touch detected data, and processes the touch detected data to generate the touch report data, wherein the touch detection procedure is determined according to the touch configuration data, the multiple control bits included in the touch configuration data are used to determine a connection configuration of at least one multiplexer to set a touch resolution profile, and a weighting configuration of at least one touch point to set a touch sensitivity profile, and the touch report data include data selected from a group consisting of data representing a sensed pressure profile exerted on the touch display module, data representing a finger print of a user, data representing a palm print, data representing an ear image, data representing at least one touched location, characteristic data of a finger print, characteristic data of a palm print, and characteristic data of an ear image.

The control unit preferably includes a timing control unit, a source driver unit, a gate driver unit, a touch driver unit, a touch detection unit, and an information processing unit.

The touch display module can include an in-cell touch display or an on-cell touch display or an out-cell touch display. The in-cell touch display or on-cell touch display has touch sensors integrated in a display, and the out-cell touch display has touch sensors stacked on a display. The touch detected data can be derived from a capacitive touch plane of the touch display module, and the touch detected data can be raw data or processed data of the raw data, wherein the raw data correspond to capacitance values detected on the capacitive touch plane.

The touch display module can further include a pressure sensor module and/or a finger print detection module, and the touch detected data can include data derived from the pressure sensor module and/or data derived from the finger print detection module.

The touch report data can further include data representing a change of the sensed pressure profile over time and/or data representing a change of a sensed touched area over time.

In addition, the touch report data can further include data representing a joystick style operation on a touch operation area, and the data representing a joystick style operation are derived according to a change of the sensed pressure profile over time or a change of a sensed touched area over time.

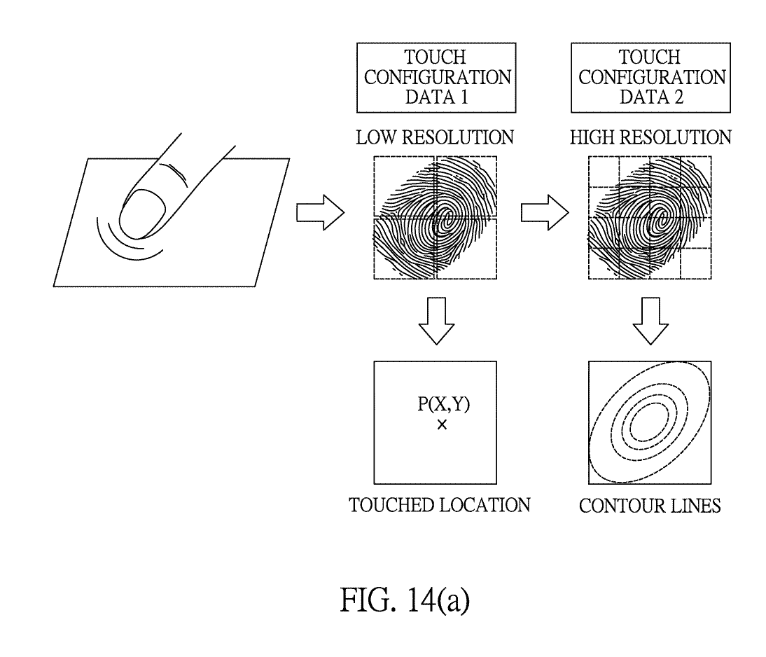

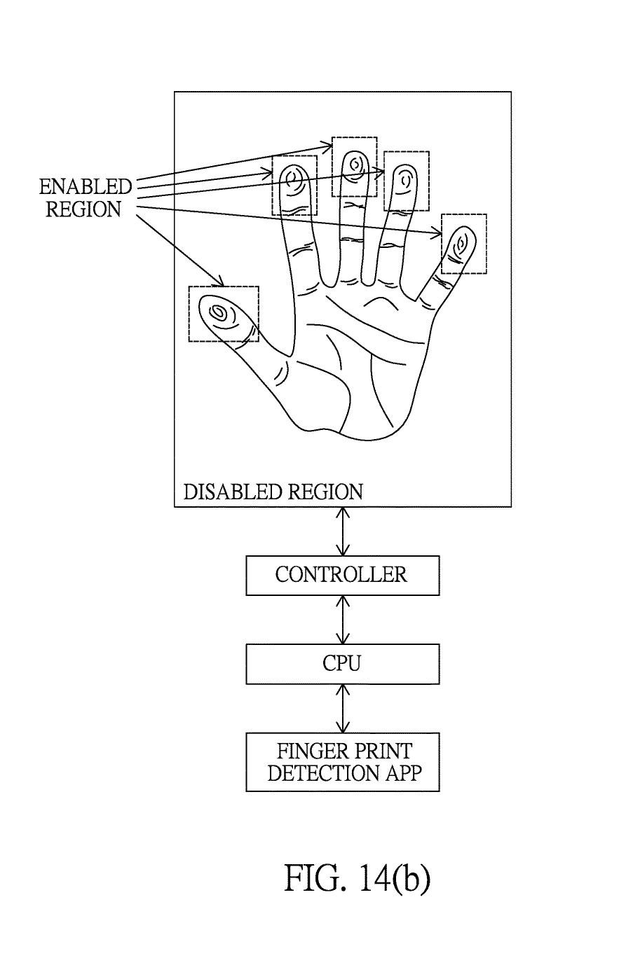

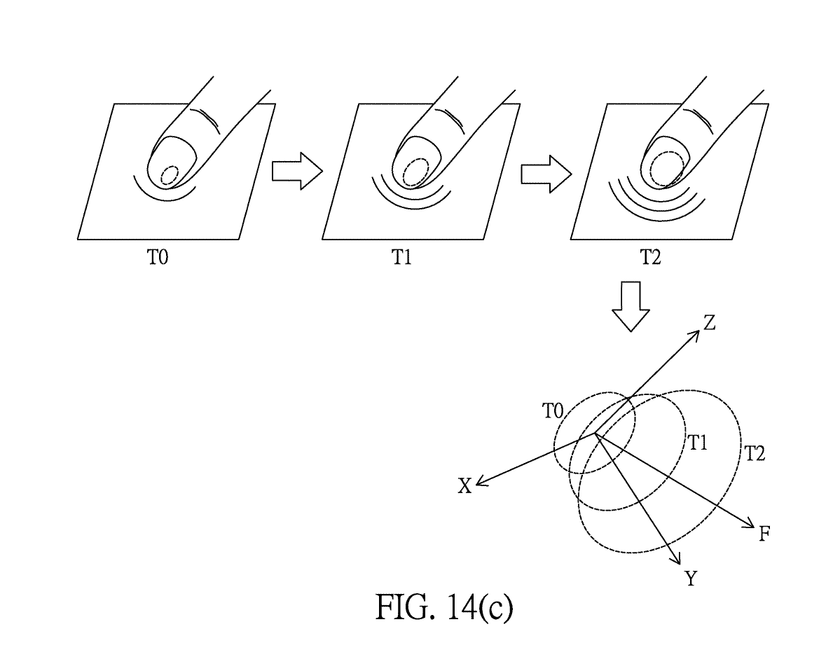

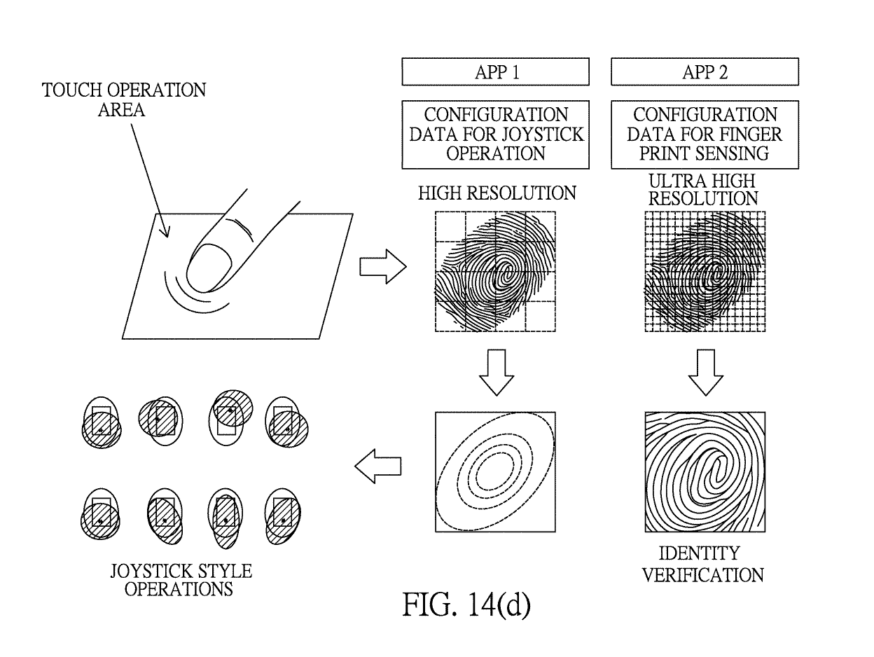

Please refer to FIG. 14(a)-14(e), which illustrates various functions that can be offered by the configurable touch resolution profile and the configurable touch sensitivity profile of the present invention. As illustrated in FIG. 14(a), by controlling the touch resolution profile and/or the touch sensitivity profile of a touch plane (the touch resolution profile is controlled by determining a connection configuration of at least one multiplexer), a touched location or a profile of contour lines of sensed values can be derived. As illustrated in FIG. 14(b), by enabling/disabling the touch operation regions of a touch plane (the enabling/disabling function is controlled by determining a weighting configuration of at least one touch point), five finger prints can be derived. As illustrated in FIG. 14(c), by controlling the touch resolution profile and the sensitivity profile of a touch plane (the touch resolution profile is controlled by determining a connection configuration of at least one multiplexer), multiple profiles of contour lines of sensed values can be derived to form a 3 dimensional profile. As illustrated in FIG. 14(d), by controlling the touch resolution profile of a touch plane (the touch resolution profile is controlled by determining a connection configuration of at least one multiplexer) according to two different APPs (application program), a change of a profile of contour lines of sensed values over time can be derived for detecting a joystick style operation for APP1, and another profile of contour lines of sensed values can be derived for identifying a finger print for APP2. As illustrated in FIG. 14(e), by utilizing the architecture of the present invention, a palm image or an ear image can be derived for identification verification of a user.

To release the workload of the control unit, some processing jobs can be transferred to the CPU side, and one embodiment is as follows: a touch display driving circuit capable of responding to CPU commands, including:

a first interface for receiving pixel data and touch configuration data from a CPU and outputting touch report data to the CPU, wherein the first interface transmits data in a serial manner or a parallel manner and the touch configuration data includes multiple control bits;

a second interface for coupling with a touch display module;

a control unit, which drives the touch display module via the second interface to show an image according to the pixel data, executes a touch detection procedure on the touch display module via the second interface to derive touch detected data, and processes the touch detected data to generate the touch report data, wherein the touch detection procedure is determined according to the touch configuration data, the multiple control bits included in the touch configuration data are used to determine a connection configuration of at least one multiplexer to set a touch resolution profile, and a weighting configuration of at least one touch point to set a touch sensitivity profile, and the CPU processes the touch report data to get data representing a sensed pressure profile exerted on the touch display module, or characteristic data of a finger print or a palm or an ear of a user, or data representing a change of the sensed pressure profile over time, or data representing a change of a sensed touched area over time.

Based on the principles elaborated above, a software-defined sensing system capable of responding to CPU commands can be further established.

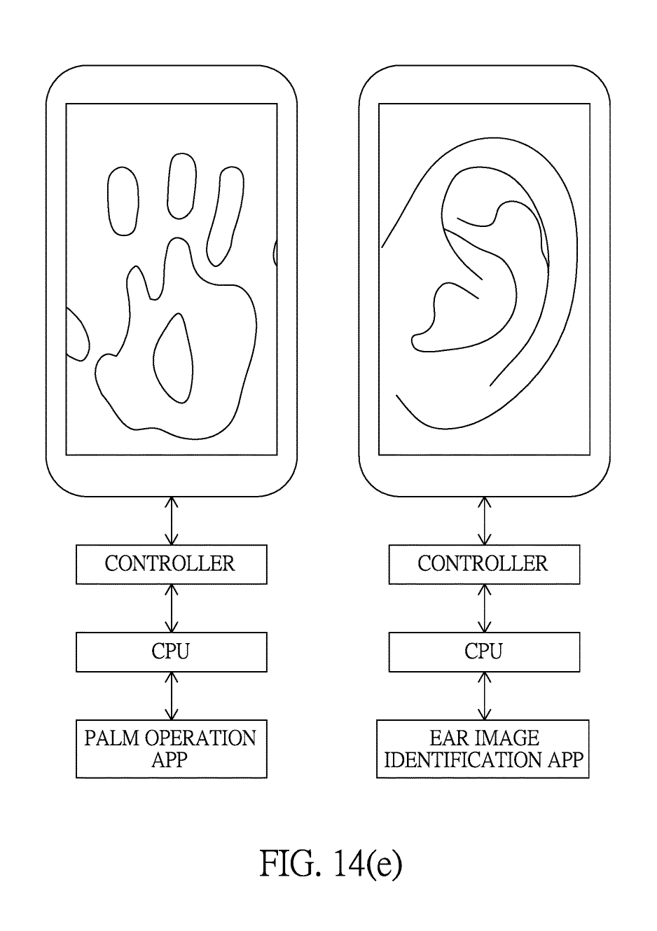

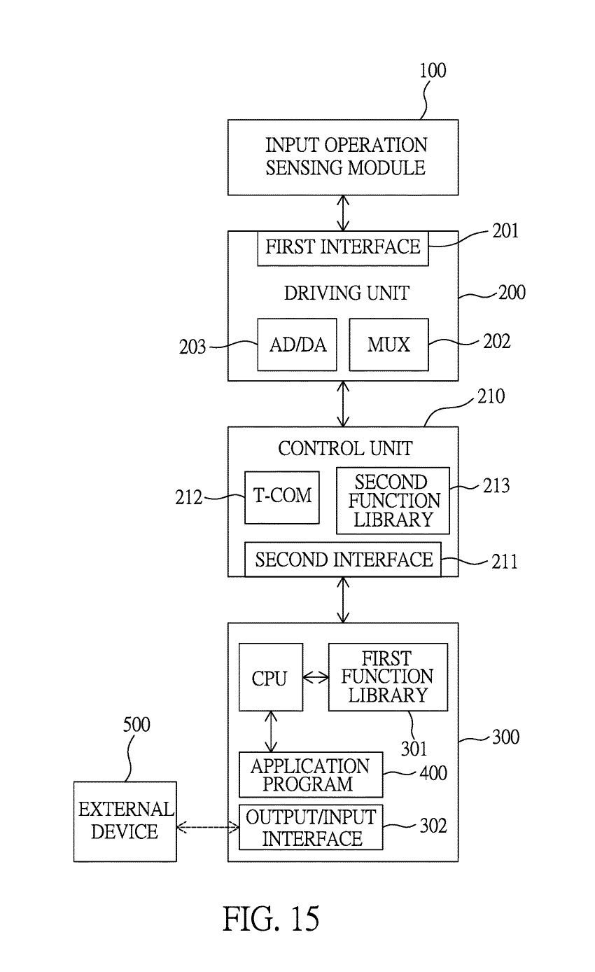

Please refer to FIG. 15, which illustrates a block diagram of a software-defined sensing system capable of responding to CPU commands according to an embodiment of the present invention. As illustrated in FIG. 15, the software-defined sensing system capable of responding to CPU commands includes at least one input operation sensing module 100, at least one driving unit 200, at least one control unit 210, at least one central processing unit 300 and at least one application program 400.

The input operation sensing module 100 has a sensing plane consisting of at least one sensing element, the at least one sensing element having at least one sensing function selected from a group consisting of force sensing function, thermal sensing function, photo sensing function, magnetic field sensing function, electrical field sensing function, acoustic wave sensing function, radiation sensing function, chemicals sensing function and biosensing function. For example, the sensing plane can include a sensor array, which can be a capacitive sensor array, a force sensor array, a photo sensor array, an acoustic wave sensor array, or a magnetic field sensor array.

The driving unit 200, preferably having a multiplexing circuit 202 and a digital-to-analog conversion circuit and/or an analog-to-digital conversion circuit 203, is used to drive an input operation sensing module 100 via a first interface 201 to execute a sensing procedure, and used to receive one kind of sensed information via the first interface 201, where the sensed information can be capacitive sensed information, force sensed information, photo sensed information, acoustic wave sensed information, or magnetic field sensed information.

For possible embodiments, the sensing procedure can include determining a connecting status of the at least one sensing element of an input operation sensing module 100; or include determining a scan rule for the at least one sensing element of an input operation sensing module 100, where the scan rule can be a one-dimension scan rule, a two-dimension scan rule, a single-layer scan rule, a double-layers scan rule, a tracking scan rule, a GUI mapping scan rule, a dynamic frequency scan rule, or a dynamic resolution scan rule; or include determining a data format of sensed information from an input operation sensing module 100, where the data format can be a raw data format, a coordinate data format, a vector data format, a biological characteristic data format, or a hybrid fusion data format.

The control unit 210, preferably having a microprocessor (not illustrated in the figure), a memory (not illustrated in the figure) and an operating timing control unit 212, is used to receive a sensors-configuration command via a second interface 211 and control a driving unit 200 according to the sensors-configuration command, where the sensors-configuration command can be sensing device enable/disable configuration command, sensing function configuration command, or sensing spec setting command.

The central processing unit 300 has a first function library 301 containing at least one sensors-configuration setting function for determining the sensors-configuration command. Besides, the central processing unit 300 can have an output/input interface 302 for communicating with an external device 500 in a wired way or wireless way.

The application program 400 is stored in a memory and to be executed by a central processing unit 300, where the application program 400 has at least one sensors-configuration function call instruction, and each of the at least one sensors-configuration function call instruction corresponds to one of the at least one sensors-configuration setting function so that when a central processing unit 300 executes an application program 400, the sensors-configuration command is generated according to a called function of the at least one sensors-configuration setting function, and the sensing procedure is determined by the sensors-configuration command, and at least one input sensing function is thereby provided. The input sensing function can be a multi-points touch function, a force sensing function, a hover sensing function, a 3D scan sensing function, a 2D image sensing function, a fingerprint sensing function, a palm-print sensing function, or a face characteristics sensing function.

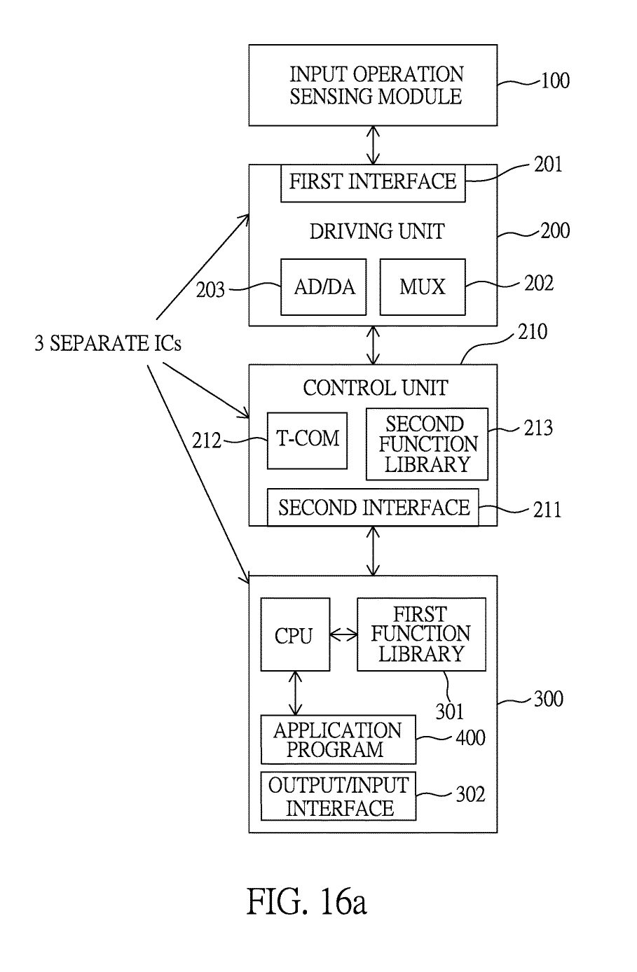

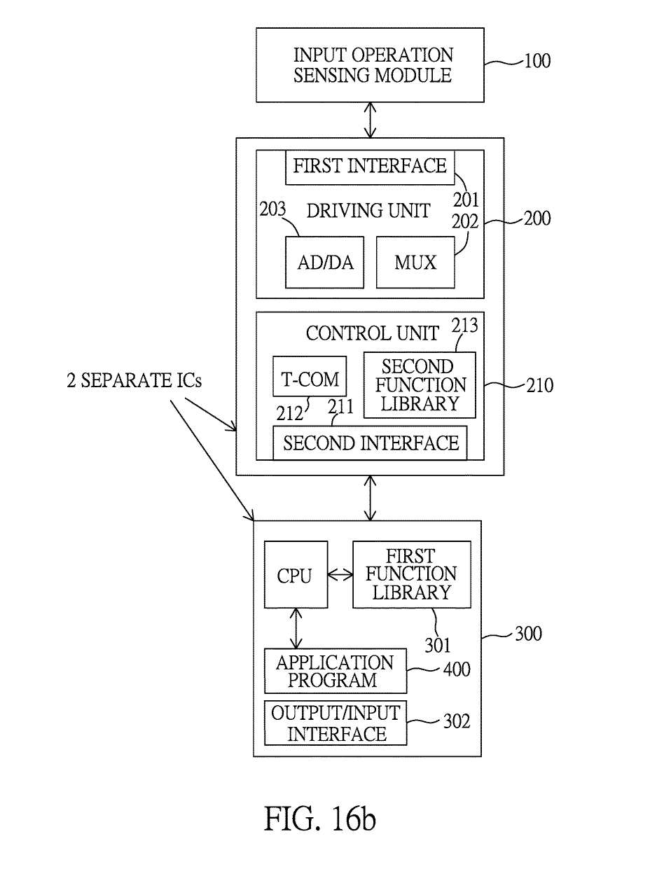

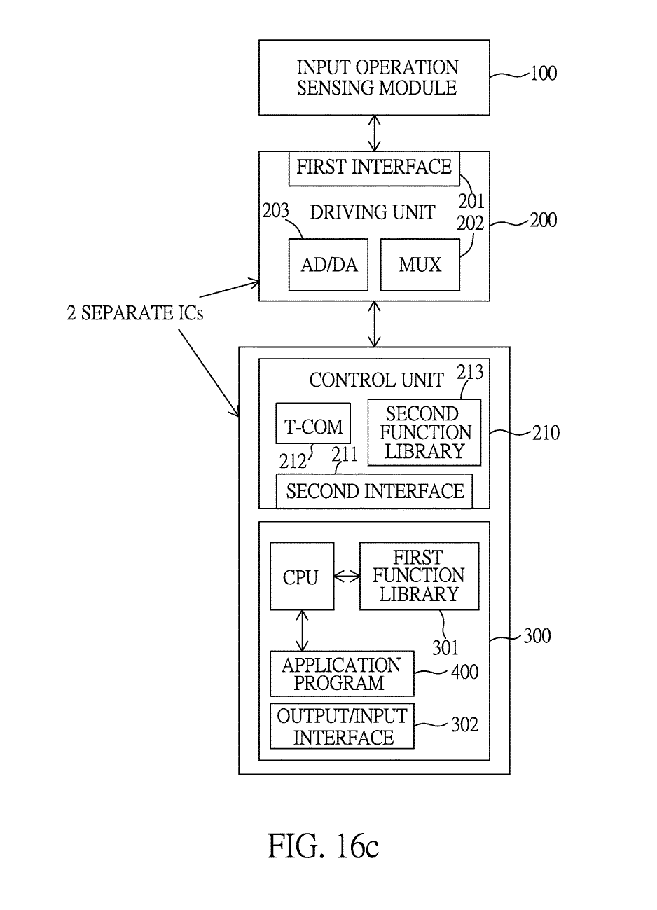

For possible embodiments, the driving unit 200 and the control unit 210 can be embodied in separated integrated circuits (as illustrated in FIG. 16a), or the driving unit 200 is integrated with the control unit 210 in an integrated circuit (as illustrated in FIG. 16b), or the control unit 210 is integrated with the central processing unit 300 in an integrated circuit (as illustrated in FIG. 16c).

In a possible embodiment, the control unit 210 can have at least one second function library 213, and each of the at least one second function library 213 contains at least one sensors-configuration determining function for generating a sensors-configuration data according one of the at least one sensors-configuration command to control a driving unit 200, and thereby determine the sensing procedure.

In a possible embodiment, the second interface is a wired transmission interface or a wireless transmission interface.

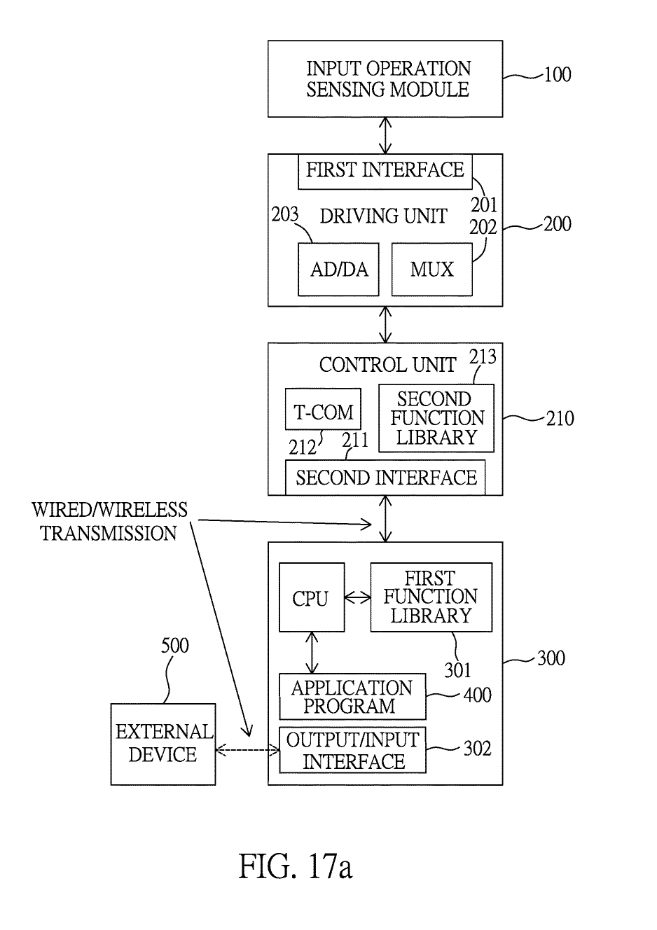

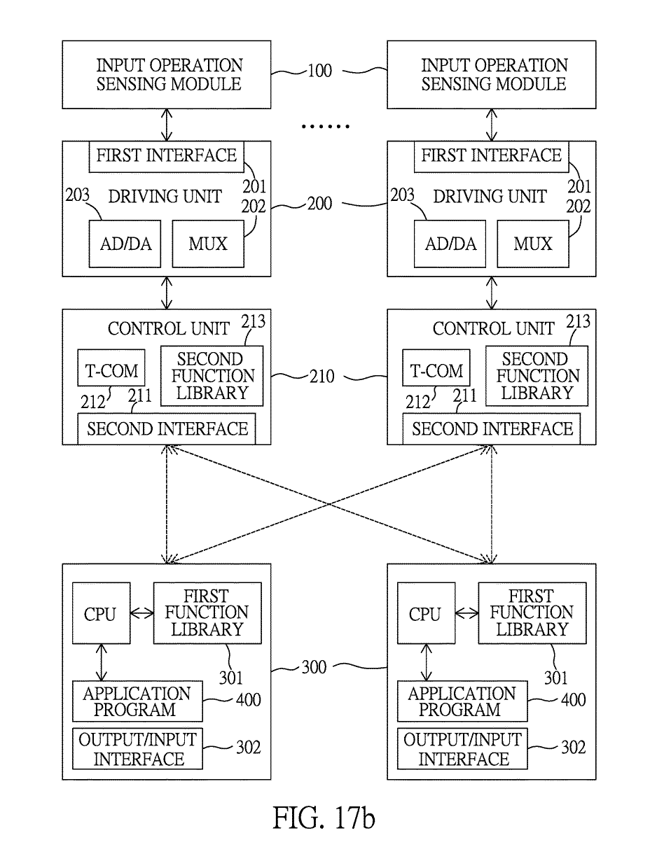

For possible embodiments, the control units 210 communicate with the central processing units 300 in a one-to-one way (as illustrated in FIG. 17a) or a one-to-many way or a many-to-one way (as illustrated in FIG. 17b).

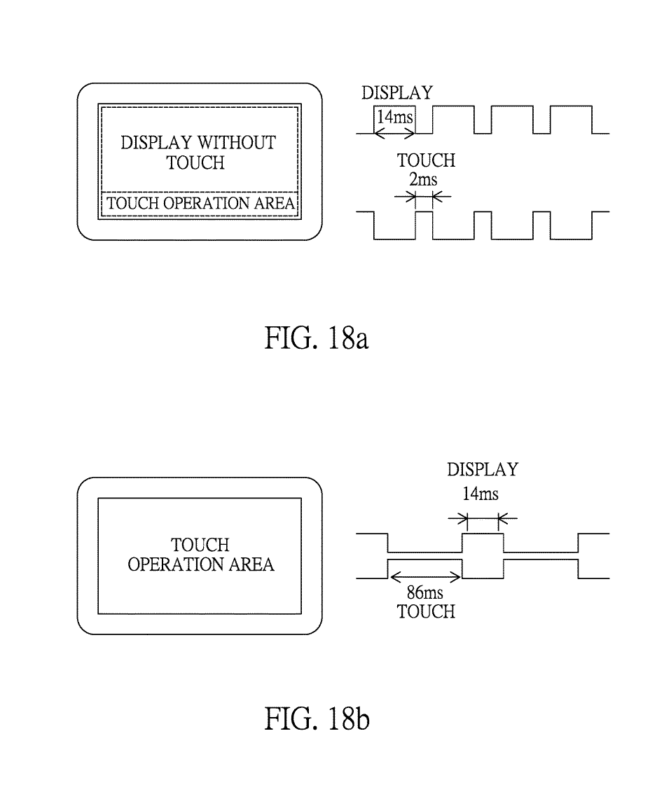

For possible embodiments, the input operation sensing module 100 can be a touch display device, and an image display procedure and a touch sensing procedure of the touch display device act on at least one same electrode simultaneously or non-simultaneously, or act on different electrodes simultaneously or non-simultaneously. The sensing procedure can include a dynamic sensing mode for a driving unit 200 to determine an operating timing and/or at least one sensing area of the sensing plane for the touch sensing procedure. FIG. 18a and FIG. 18b illustrate timing diagrams of image display and touch sensing for two embodiments of the dynamic sensing mode. Besides, the touch display device can also be combined with a plurality of the input operation sensing modules to provide a hybrid input operation sensing function.

Based on the foregoing schemes, the present invention can therefore utilize the first function library 301 and/or the second function library 213 to provide a variety of functions. In one possible embodiment, the application program 400 is supported by an OS (operating system) in the central processing unit 300, and the first function library 301 and/or the second function library 213 are/is used by the application program 400 to generate different input sensing functions and/or different sensing specs according to instructions of the application program. In another possible embodiment, the application program 400 is supported by a first OS (operating system) in the central processing unit 300, and the control unit 210 has a local application program supported by a second OS (operating system), the first function library 301 is used by the application program 400 to generate different first input sensing functions and/or different first sensing specs, and the second function library 213 is used by the local application program to generate different second input sensing functions and/or different second sensing specs.

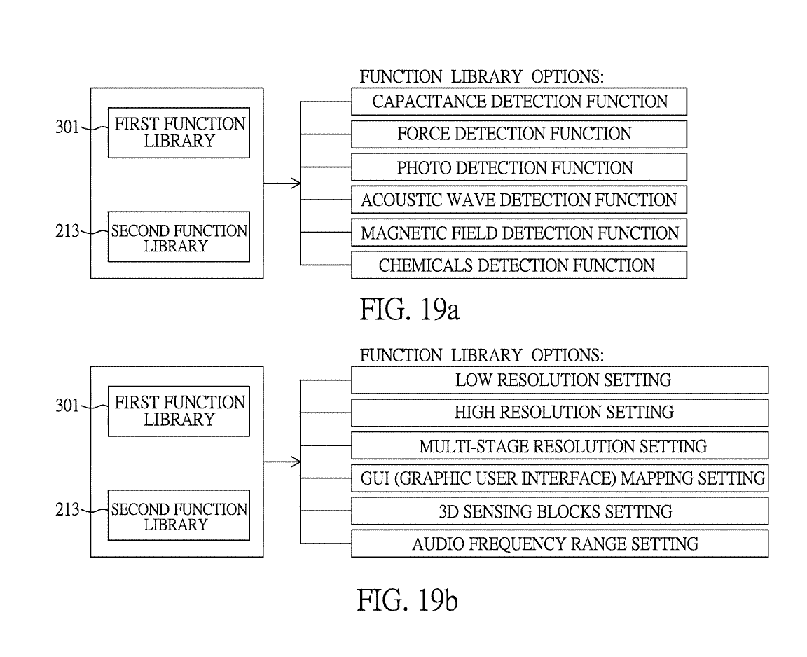

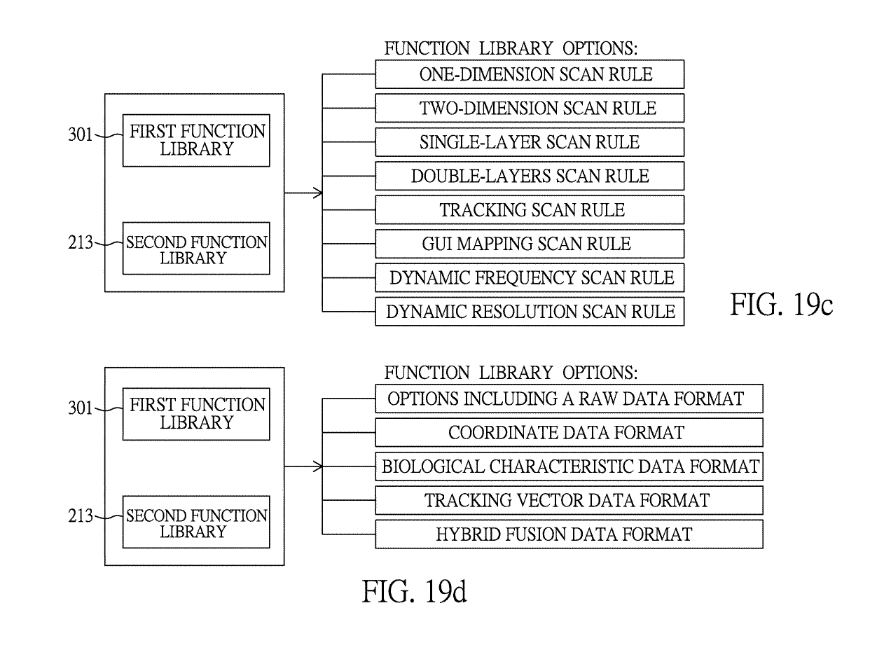

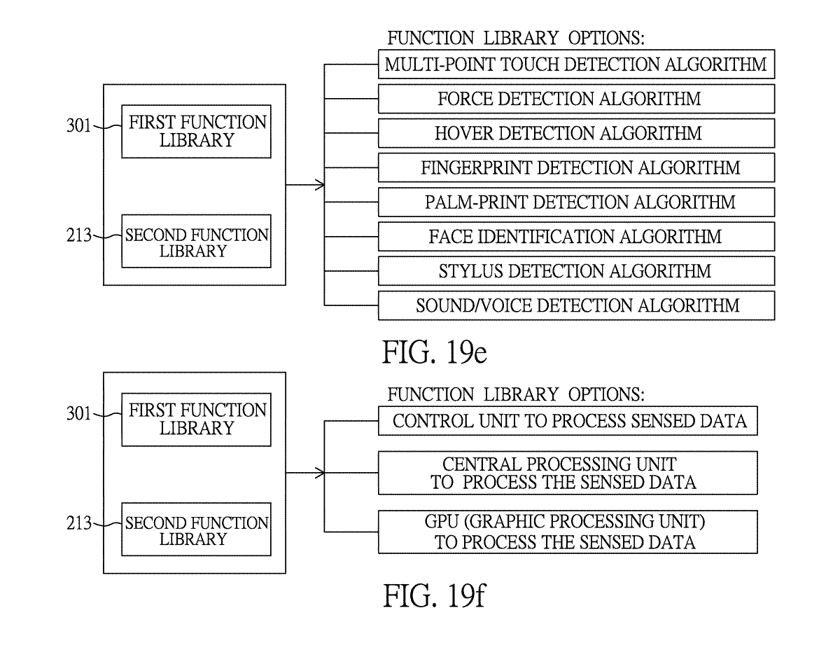

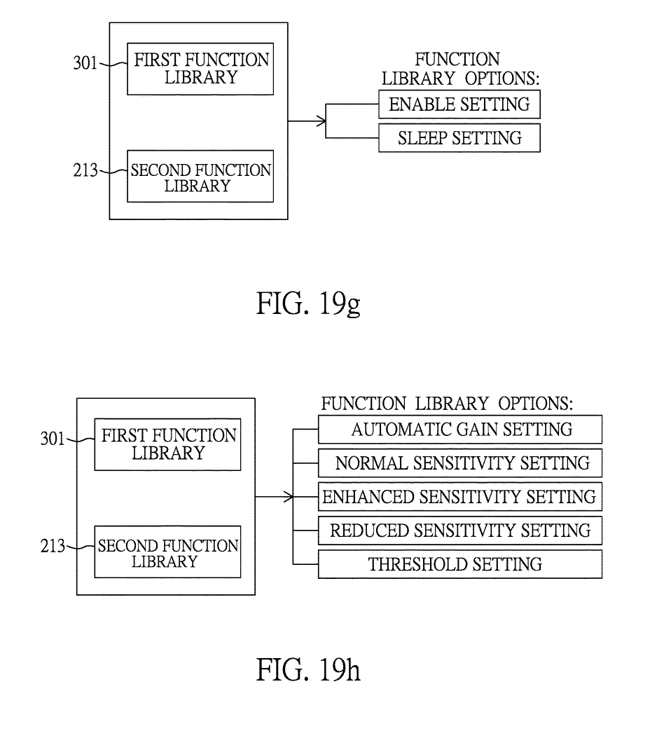

Please refer to FIG. 19a, which illustrates a plurality of function library options provided by the first function library 301 and/or the second function library 213 according to an embodiment of the present invention, the function library options including a capacitance detection function, a force detection function, a photo detection function, an acoustic wave detection function, a magnetic field detection function, and a chemicals detection function. The application program 400 can select at least one option from the plurality of function library options.

Please refer to FIG. 19b, which illustrates a plurality of function library options provided by the first function library 301 and/or the second function library 213 according to another embodiment of the present invention, the function library options being related to a sensing spec setting, and the options including a low resolution setting, a high resolution setting, a multi-stage resolution setting, a GUI (graphic user interface) mapping setting, a 3D sensing blocks setting, and an audio frequency range setting.

Please refer to FIG. 19c, which illustrates a plurality of function library options provided by the first function library 301 and/or the second function library 213 according to another embodiment of the present invention, the function library options being related to a scan rule setting, and the options including a one-dimension scan rule, a two-dimension scan rule, a single-layer scan rule, a double-layers scan rule, a tracking scan rule, a GUI mapping scan rule, a dynamic frequency scan rule, and a dynamic resolution scan rule.

Please refer to FIG. 19d, which illustrates a plurality of function library options provided by the first function library 301 and/or the second function library 213 according to another embodiment of the present invention, the function library options being related to a sensed data format setting, and the options including a raw data format, a coordinate data format, a biological characteristic data format, a tracking vector data format, and a hybrid fusion data format.

Please refer to FIG. 19e, which illustrates a plurality of function library options provided by the first function library 301 and/or the second function library 213 according to another embodiment of the present invention, the function library options being related to a detection algorithm setting, and the options including a multi-point touch detection algorithm, a force detection algorithm, a hover detection algorithm, a fingerprint detection algorithm, a palm-print detection algorithm, a face identification algorithm, a stylus detection algorithm, and a sound/voice detection algorithm.

Please refer to FIG. 19f, which illustrates a plurality of function library options provided by the first function library 301 and/or the second function library 213 according to another embodiment of the present invention, the function library options being related to selecting a processing resource to process sensed data, and the options including selecting the control unit to process sensed data, selecting a central processing unit to process the sensed data, and selecting a GPU (graphic processing unit) to process the sensed data.

Please refer to FIG. 19g, which illustrates a plurality of function library options provided by the first function library 301 and/or the second function library 213 according to another embodiment of the present invention, the function library options being related to a power saving setting, and the options including an enable setting, and a sleep setting.

Please refer to FIG. 19h, which illustrates a plurality of function library options provided by the first function library 301 and/or the second function library 213 according to still another embodiment of the present invention, the function library options being related to a sensing sensitivity setting, and the options including an automatic gain setting, a normal sensitivity setting, an enhanced sensitivity setting, a reduced sensitivity setting, and a threshold setting.

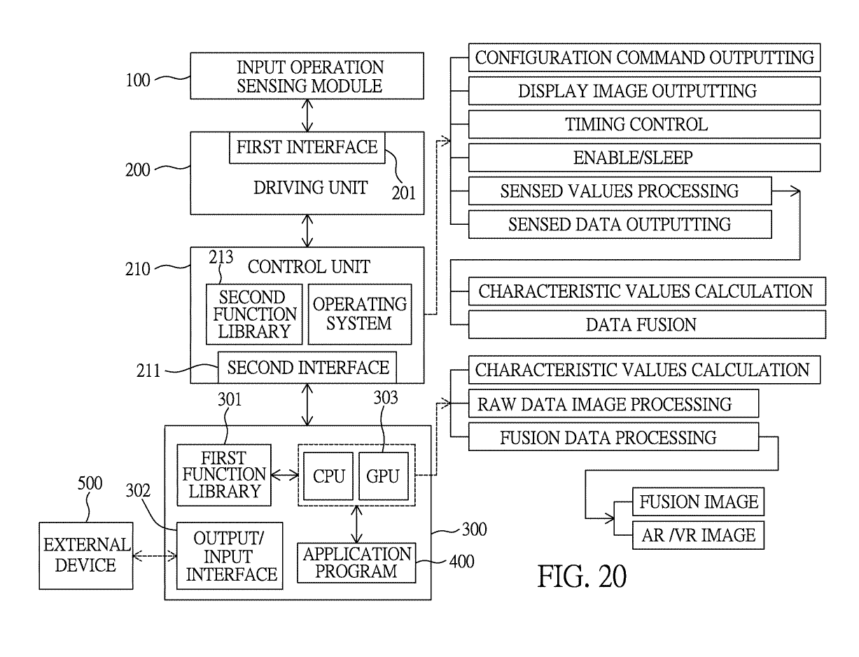

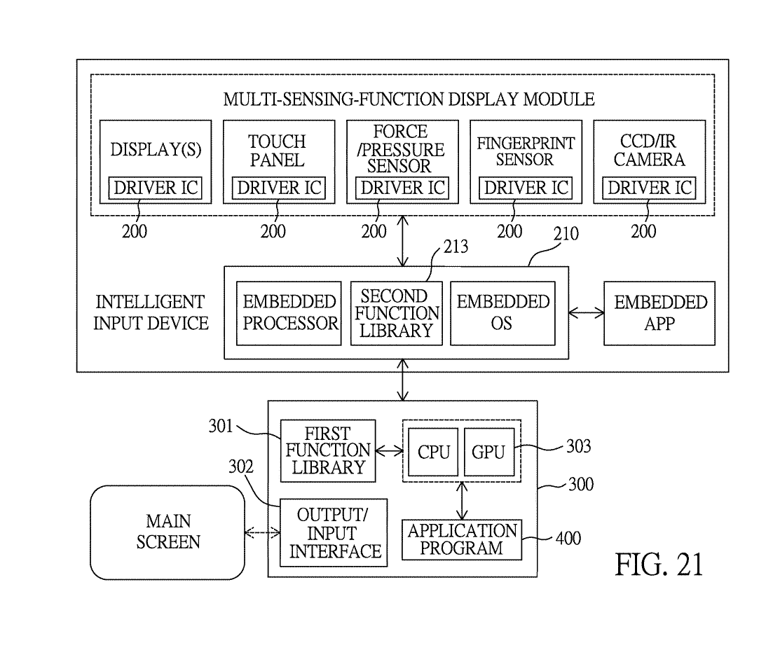

Besides, please refer to FIG. 20, which illustrates a block diagram of a software-defined sensing system capable of responding to CPU commands according to another embodiment of the present invention. As illustrated in FIG. 20, the central processing unit 300 has an embedded GPU 303, and the control unit 210 has an operating system, where the GPU 303 can be used to execute a characteristic values operation, a raw data image processing procedure, or a fusion data processing procedure, where the fusion data can be from a fusion image or an AR (augmented reality)/VR (virtual reality) image; and the operating system can be used to execute an operation configuration command outputting procedure, a display image outputting procedure, a timing control procedure, an enable/sleep procedure, a sensed values processing procedure (characteristic values calculation or data fusion operation) or a sensed data outputting procedure.

Besides, the intelligent device can be an intelligent input device, an intelligent vehicle control device, or an intelligent IOT (internet of things) device.

Please refer to FIG. 21, which illustrates a scenario that the software-defined sensing system capable of responding to CPU commands of the present invention is used to implement an intelligent input device. As illustrated in FIG. 21, the intelligent input device can provide a touch input function, a force sensing function, a fingerprint identification function, and a CCD (charge-coupled device)/IR (infrared) image input function.

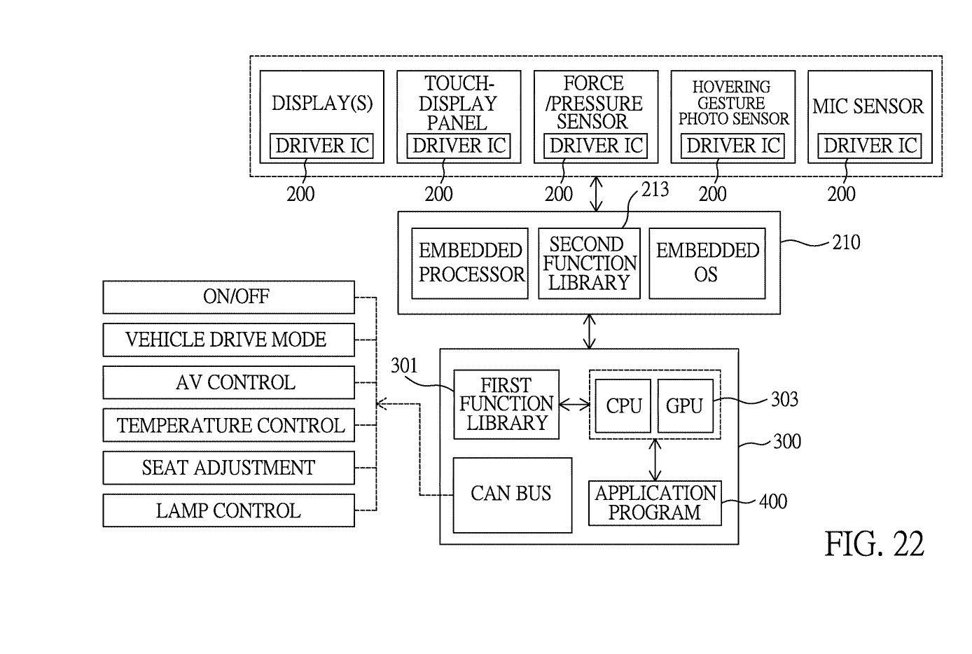

Please refer to FIG. 22, which illustrates a scenario that the software-defined sensing system capable of responding to CPU commands of the present invention is used to implement an intelligent vehicle control device. As illustrated in FIG. 22, the intelligent vehicle control device can provide a touch input function, a force sensing function, a hover gesture image sensing function, and a microphone based voice detection function, and can control plural parts of a vehicle via a CAN (controller area network) bus.

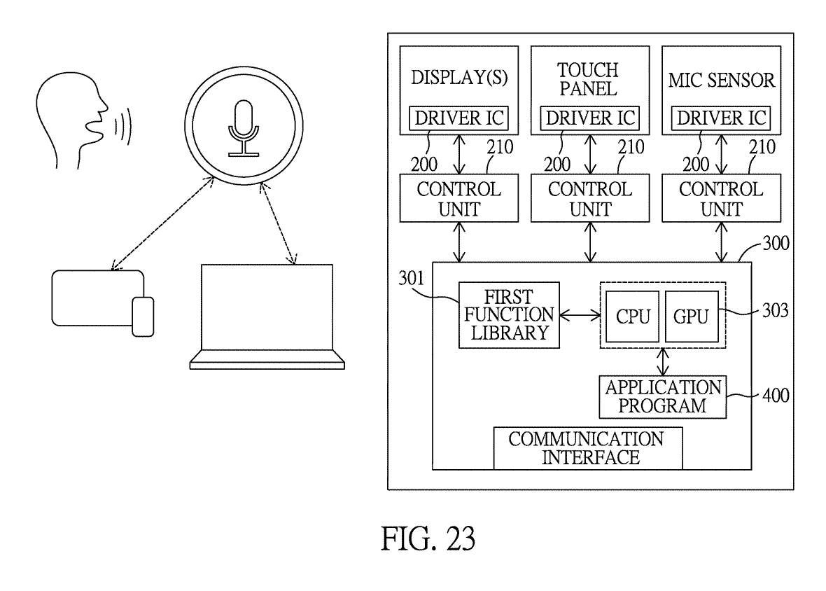

Please refer to FIG. 23, which illustrates a scenario that the software-defined sensing system capable of responding to CPU commands of the present invention is used to implement an intelligent IOT device. As illustrated in FIG. 23, the intelligent IOT device can provide a touch input function and a microphone based voice detection function, and can control at least one external device via a communication interface (wired or wireless).

Thanks to the novel designs mentioned above, the present invention possesses the following advantages:

1. The driving circuit of the present invention can configure and execute a touch detection procedure according to a CPU's commands.

2. The driving circuit of the present invention can receive a touch configuration data from a CPU, wherein the touch configuration data has multiple control bits for determining a connection configuration of at least one multiplexer and a weighting configuration of at least one touch point.

3. The driving circuit of the present invention can receive a touch configuration data from a CPU, wherein the touch configuration data has at least one control bit for enabling/disabling at least one touch point.

4. The driving circuit of the present invention can receive a touch configuration data from a CPU, and use the touch configuration data to provide a resistor-capacitor delay compensation function.

5. The driving circuit of the present invention can receive a touch configuration data from a CPU, and use the touch configuration data to provide a dynamic driving function.

6. The driving circuit of the present invention can receive a touch configuration data from a CPU, and use the touch configuration data to provide an adaptive driving function.

7. The driving circuit of the present invention can receive a touch configuration data from a CPU, and use the touch configuration data to provide a multi-stage driving function.

8. The driving circuit of the present invention can receive a touch configuration data from a CPU, and use the touch configuration data to provide a three-dimensional touch detection function.

9. The driving circuit of the present invention can receive a touch configuration data from a CPU, and use the touch configuration data to provide a graphical user interface touch detection function.

10. The driving circuit of the present invention can configure a touch resolution profile and a touch sensitivity profile according to a CPU's commands so as to facilitate detecting a pressure profile on a touch operation area and/or a change of the pressure profile over time.

11. The driving circuit of the present invention can configure a touch resolution profile and a touch sensitivity profile according to a CPU's commands so as to facilitate detecting a finger print of a user and/or characteristic data thereof.

12. The driving circuit of the present invention can configure a touch resolution profile and a touch sensitivity profile according to a CPU's commands so as to facilitate detecting a palm print of a user and/or characteristic data thereof.

13. The driving circuit of the present invention can configure a touch resolution profile and a touch sensitivity profile according to a CPU's commands so as to facilitate detecting an ear image of a user and/or characteristic data thereof.

14. The software-defined sensing system capable of responding to CPU commands of the present invention can provide a first function library and/or a second function library for an application program to utilize to specify at least one input sensing interface via modularized instructions, and thereby meet the requirement of at least one input sensing mode.

15. The software-defined sensing system capable of responding to CPU commands of the present invention can provide at least one sensing spec according to instructions of an application program so as to determine a sensing signal detection mode and a sensed data output format.

16. The software-defined sensing system capable of responding to CPU commands of the present invention can provide at least one sensing function according to instructions of an application program, and the at least one sensing function can be a physical parameter sensing function, a chemical parameter sensing function, or a biological parameter sensing function.

17. The software-defined sensing system capable of responding to CPU commands of the present invention can be applied to an intelligent input device, an intelligent vehicle control device, or an intelligent IOT device.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. a software-defined sensing system capable of responding to CPU commands for implementing an intelligent device, including:
at least one input operation sensing module, each having a sensing plane consisting of at least one sensing element, the at least one sensing element having at least one sensing function selected from a group consisting of force sensing function, thermal sensing function, photo sensing function, magnetic field sensing function, electrical field sensing function, acoustic wave sensing function, radiation sensing function, chemicals sensing function and biosensing function;
at least one driving unit, each being used for driving one of the at least one input operation sensing module via at least one first interface to execute a sensing procedure, and receiving a kind of sensed information via the at least one first interface;
at least one control unit, each being used for receiving a sensors-configuration command via at least one second interface to generate the sensing procedure;
at least one central processing unit, having at least one first function library, the at least one first function library containing at least one sensors-configuration setting function to determine the sensors-configuration command; and
at least one application program, stored in at least one memory and to be executed by the at least one central processing unit;
wherein, each of the at least one application program has at least one sensors-configuration function call instruction, and each of the at least one sensors-configuration function call instruction corresponds to one of the at least one sensors-configuration setting function so that when the at least one central processing unit executes the at least one application program, the sensors-configuration command is generated according to a called function of the at least one sensors-configuration setting function, and the sensing procedure is determined by the sensors-configuration command, and at least one input sensing function is thereby provided.

2. The software-defined sensing system as disclosed in claim 1, wherein each of the at least one control unit has a microprocessor, a memory and an operating timing control unit.

3. The software-defined sensing system as disclosed in claim 1, wherein each of the at least one driving unit has a multiplexing circuit, and a digital-to-analog conversion circuit and/or an analog-to-digital conversion circuit.

4. The software-defined sensing system as disclosed in claim 1, wherein each of the at least one driving unit and each of the at least one control unit are embodied in separated integrated circuits, or each of the at least one driving unit is integrated with one of the at least one control unit in an integrated circuit.

5. The software-defined sensing system as disclosed in claim 1, wherein each of the at least one control unit is integrated with one of the at least one central processing unit in an integrated circuit.

6. The software-defined sensing system as disclosed in claim 1, wherein the at least one control unit has at least one second function library, each of the at least one second function library contains at least one sensors-configuration determining function for generating a sensors-configuration data according one of the at least one sensors-configuration command to control one of the at least one driving unit, and thereby determine the sensing procedure.

7. The software-defined sensing system as disclosed in claim 6, wherein the application program is supported by an OS in the central processing unit, and the first function library and/or the second function library are/is used by the application program to generate the at least one input sensing function and/or at least one sensing spec according to instructions of the application program; or the application program is supported by a first OS in the central processing unit, and the control unit has a local application program supported by a second OS, the first function library is used by the application program to generate at least one first function of the at least one input sensing function and/or at least one first sensing spec, and the second function library is used by the local application program to generate at least one second function of the at least one input sensing function and/or at least one second sensing spec.

8. The software-defined sensing system as disclosed in claim 1, wherein the sensors-configuration command is selected from a group consisting of sensing device enable/disable configuration command, sensing function configuration command, and sensing spec setting command.

9. The software-defined sensing system as disclosed in claim 1, wherein the second interface is a wired transmission interface or a wireless transmission interface, and the central processing unit communicates with an external device in a wired transmission way or a wireless transmission way.

10. The software-defined sensing system as disclosed in claim 1, wherein the at least one control unit communicates with the at least one central processing unit in a one-to-one way or a one-to-many way or a many-to-one way.

11. The software-defined sensing system as disclosed in claim 1, wherein the input sensing function is selected from a group consisting of multi-points touch function, force sensing function, hover sensing function, 3D scan sensing function, 2D image sensing function, fingerprint sensing function, palm-print sensing function, and face characteristics sensing function.

12. The software-defined sensing system as disclosed in claim 1, wherein the sensing procedure includes determining a connecting status of the at least one sensing element of one of the at least one input operation sensing module.

13. The software-defined sensing system as disclosed in claim 1, wherein the sensing procedure includes determining a scan rule for the at least one sensing element of one of the at least one input operation sensing module.

14. The software-defined sensing system as disclosed in claim 1, wherein the sensing procedure includes determining a data format of sensed information from one of the at least one input operation sensing module.

15. The software-defined sensing system as disclosed in claim 1, wherein the input operation sensing module includes a sensor array selected from a group consisting of capacitive sensor array, force sensor array, photo sensor array, acoustic wave sensor array, and magnetic field sensor array.

16. The software-defined sensing system as disclosed in claim 1, wherein at least one of the at least one input operation sensing module is a touch display device, and an image display procedure and a touch sensing procedure of the touch display device act on at least one same electrode simultaneously or non-simultaneously, or act on different electrodes simultaneously or non-simultaneously.

17. The software-defined sensing system as disclosed in claim 16, wherein the sensing procedure includes a dynamic sensing mode for one of the at least one driving unit to determine an operating timing and/or at least one sensing area of the sensing plane for the touch sensing procedure.

18. The software-defined sensing system as disclosed in claim 16, wherein the touch display device is combined with a plurality of the input operation sensing modules to provide a hybrid input operation sensing function.

19. The software-defined sensing system as disclosed in claim 1, wherein the intelligent device is an intelligent input device, an intelligent vehicle control device, or an intelligent IOT device.
